(19) United States
(12) Patent Application Publication
(10) Pub. No.: US 2002/0016964 A1
(43) Pub. Date: Feb. 7, 2002

(54) Information processing apparatus and method, data broadcasting receiving apparatus, and printer

(76) Inventors: Shuntaro Aratani, Tokyo (JP); Tomoyuki Ohno, Ebina-shi (JP)

Correspondence Address: FITZPATRICK CELLA HARPER & SCINTO, 30 ROCKEFELLER PLAZA, NEW YORK, NY, 10112, US

(21) Appl. No.: 09/818,545

(22) Filed: Mar. 28, 2001

(30) Foreign Application Priority Data
Mar. 30, 2000 (JP) 2000-094915
Feb. 28, 2001 (JP) 2001-054663

(51) Int. Cl. G06F 13/00; H04N 5/445; G06F 3/00

(52) U.S. Cl. 725/39

(57) ABSTRACT

An information processing apparatus includes: an input unit for entering a data string composed of a plurality of information output to a display unit; an extractor for automatically extracting information from a data string entered by the input unit according to a predetermined condition; a generator for generating print data for printing out information extracted by the extractor; and an output unit for outputting print data generated by the generator to a printer.

### BACKGROUND OF THE INVENTION

1. Field of the Invention

The present invention relates to an information processing apparatus or a TV signal receiver. More particularly, the present invention relates to an apparatus for controlling display of images of a TV program.

2.Related Background Art

Data-broadcasting has been started in some of broadcasting stations that have involved in the present ground wave TV broadcasting, as well as in some of satellite TV broadcasting stations. Such the data-broadcasting is all done by superimposing data originated from each of those broadcasting stations on the broadcast waves. Each receiver then reads the data received and stored in a personal computer and/or in a dedicated terminal, then displays the data with use of a general-purpose WWW (World Wide Web) browser software program.

The present digital satellite TV broadcasting that uses a BS (Broadcast Satellite) employs TV receivers so as to provide new services. Concretely, data-broadcasting receiving functions and a browser software program are installed in each of those TV receivers, thereby enabling the users to read various information items easily even when they do not have personal computers yet and providing services, each for enabling information ganged with TV-programs to be displayed with characters and images. For example, a news service, which is sent by such the data-broadcasting, presents users with a data-broadcasting screen consisting of characters and images as “a news item” and reproduces movie images of the news item selected by individual users via a remote control device, etc. respectively The news movie images of the data-broadcasting screen are recorded beforehand in a recording apparatus of the TV receiver.

With such a service enabled, other new services that have never been provided so far have come to be provided to the users. For example, each user can enjoy news programs any time, although it has been enabled just in real time and at a fixed time conventionally. In addition, each user can also enjoy only news items selected by himself/herself.

In the case where the above data-broadcasting receiving functions are installed in a TV receiver, however, the data is usually displayed in a larger font so as to make it easy for the user to see it. As a result, the number of characters to be displayed at a time on the screen becomes less. For example, in the case of the news service described above, it has been managed so that a news item is divided so as to be displayed on 3 to 5 screen; it has often been too many news items to be displayed together with their abstracts and photos.

There may be considered countermeasures for scrolling and changing pages so as to display information items that cannot be displayed at a time. In this case, however, the user is forced to unnecessary and troublesome operations. For users who are not familiar with operations of personal computers and video games, the countermeasures will not be so proper.

Such the conventional technique has not yet realized a user-friendly environment in which each user can find only necessary information from among many information items of the data-broadcasting. And naturally, it has been demanded to improve the conventional technique to more simple and easy one.

Furthermore, in the case where a plurality of users share one TV receiver, each user will have a desired program that is often different from others and it has been complicated and inconvenient for the user to search a desired program in such the environment.

### SUMMARY OF THE INVENTION

Under such circumstances, it is an object of the present invention to solve the above conventional problems and improve the user interface in a TV receiver, etc. that can receive data-broadcasting, thereby enabling each user to select his/her desired information from among many information items provided thereto only with a simple operation.

It is another object of the present invention to make it easier to watch a data-broadcasting program with use of printed data, thereby providing each of a plurality of users with information related to his/her most proper data-broadcasting program and enabling the user to watch the broadcasting program with a simple operation.

In order to achieve the above objects, the present invention provides an information processing apparatus, comprising: input means for entering a data string composed of a plurality of information, said data string being output onto display means; extracting means for extracting information automatically from said data string entered by said input means according to a predetermined condition; generating means for generating print data for printing the information extracted by said extracting means; and output means for outputting the print data generated by said generating means to printing means in an embodiment thereof.

Other objects, advantages, and capabilities of the present invention will become more apparent as the description proceeds taken in conjunction with the following accompanying drawings.

### BRIEF DESCRIPTION OF THE DRAWINGS

FIG. 1 is an entire block diagram of a digital TV receiver in a first embodiment of the present invention;

FIG. 2 is a block diagram of a remote control device of a TV receiver;

FIG. 3 is a configuration of microcomputer software programs;

FIG. 4 shows an example of receiving XML data;

FIG. 5 shows an example of XML data for a display in the first embodiment of the present invention;

FIG. 6 is an example of a result of printing in the first embodiment of the present invention;

FIG. 7 is a flowchart for describing an operation of a CPU 108 for receiving a data-broadcasting program in the first embodiment of the present invention;

FIG. 8 is a flowchart for describing the operation of the CPU 108 for generating XML data for printing from receiving XML data;

FIG. 9 shows an example of XML data for printing;

FIG. 10 shows an entire view of a printed XML data form;

FIG. 11 is a partially expanded view of the printed XML data form;

FIG. 12 is a flowchart for describing the operation of the CPU 108 for watching data-broadcasting;

FIG. 13 is a flowchart for describing the operation of the CPU 108 for receiving data-broadcasting in a second embodiment of the present invention;

FIG. 14 shows an example of a printed form in the second embodiment of the present invention;

FIG. 15 shows an example of XML data for a display in the second embodiment of the present invention;

FIG. 16 is a flowchart for describing the operation of the CPU 108 for enabling a user to enter a user code in the second embodiment of the present invention;

FIG. 17 shows a display screen in the second embodiment of the present invention;

FIG. 18 shows information stored in a memory in a third embodiment of the present invention;

FIG. 19 shows information stored in a memory in the third embodiment of the present invention;

FIG. 20 is a flowchart for describing the whole operation of the CPU 108 from receiving of data-broadcasting data to printing the data in the third embodiment of the present invention;

FIG. 21 shows a weekly table used by the CPU 108;

FIG. 22 is a flowchart for describing the details of a “processing A”;

FIG. 23 shows an example of XML data for printing in the third embodiment of the present invention;

FIG. 24 is a flowchart for describing a top news processing;

FIG. 25 is a flowchart for describing a detailed output processing;

FIG. 26 is a flowchart for describing the details of each category news processing;

FIG. 27 is a flowchart continued from FIG. 26;

FIG. 28 is a flowchart for describing the details of a title output processing;

FIG. 29 is a flowchart for describing an advertisement processing;

FIG. 30 is a flowchart for describing an advertisement output processing;

FIG. 31 shows a printing result of the “processing A”;

FIG. 32 shows the number of news items and positional information added to XML data for printing as a result of a “processings A to D”;

FIG. 33 shows a simple layout made by a processing B”;

FIG. 34 is a flowchart for recording reservation of a data-broadcasting program by a user;

FIG. 35 shows parameters set for the number of printing items and display positions in each category in “processings E, F, F, and H”;

FIG. 36 is a flowchart for watching a data-broadcasting program;

FIG. 37 is a flowchart for describing the details of a “processing X” in a fourth embodiment of the present invention;

FIG. 38 is a flowchart continued from FIG. 37;

FIG. 39 shows the number of information items output by the “processing X” and the printing layout; and

FIGS. 40A and 40B show printing results of the processing X” and a “processing Y”.

### DETAILED DESCRIPTION OF THE PREFERRED EMBODIMENTS

Hereunder, the preferred embodiments of the present invention will be described with reference to the accompanying drawings.

[First Embodiment]

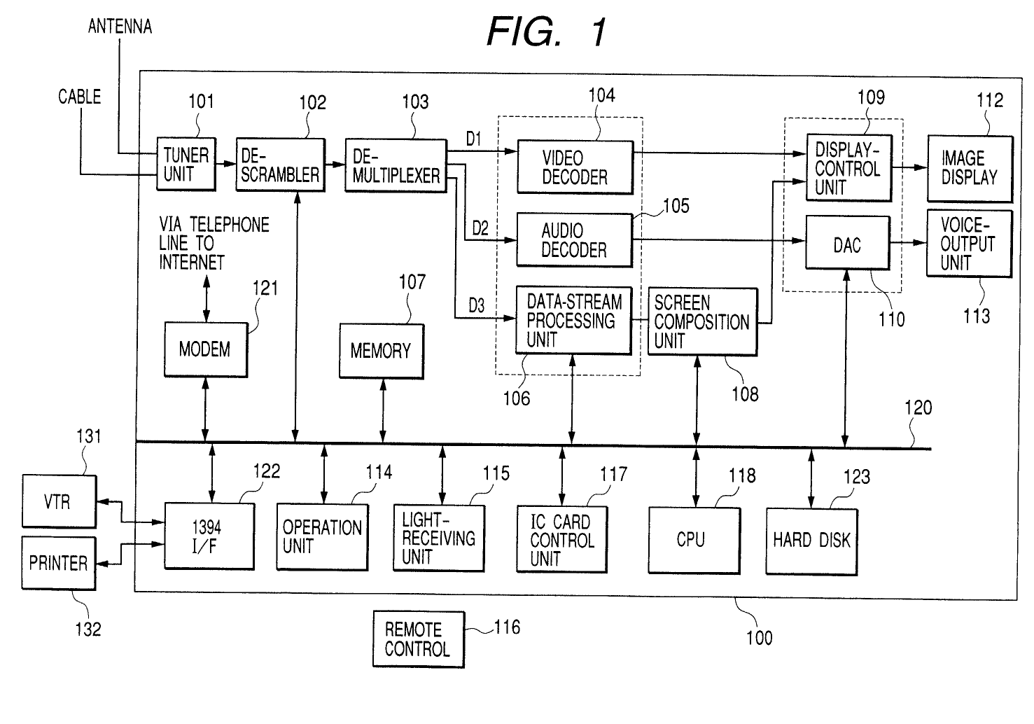

FIG. 1 is an entire block diagram of a digital TV receiver in a first embodiment of the present invention.

In this digital TV receiver 100, signals received by an antenna (not shown) are entered to a tuner unit 101. The tuner unit 101 then performs such processings as demodulation, error correction, etc. for those entered signals, thereby generating digital data in a format referred to as a transport stream. In addition, the tuner unit 101 outputs the generated transport stream (TS) data to a descrambler 102.

The descrambler 102, when receiving TS data scrambled so as to limit the watching from the tuner unit 101, descrambles the received TS data according to the descrambling key information included in the received TS data and the key information output from an IC card control unit 117, then outputs the descrambled TS data to a demultiplexer 103.

In this case, the IC card control unit 117 is provided with an IC card that stores contract information of the user and the key information used to decode the descrambling key information included in received TS data. In the case where the IC card control unit 117 detects such key information used to decode the descrambling key information received from a descrambler 102, the IC card control unit 117 outputs the key information to the descrambler 102.

The descrambler 102, when receiving non-scrambled TS data from the tuner unit 101, outputs the TS data as is to the demultiplexer 103.

The demultiplexer 103 then takes out movie data D1 and voice data D2 related to the currently broadcasting program via the channel selected by the control unit 114 or remote control device 116 from the TS data in which movie data, voice data, electronic program guide (EPG) data, data-broadcasting data, etc. are multiplexed in time series for a plurality of channels, entered from the descrambler 102. The demultiplexer 103 then outputs each of the D1 and D2 data to the video decoder 104 and the audio decoder 105 respectively.

Furthermore, the demultiplexer 103 takes out data-broadcasting/EPG data D3 from the TS decoder and enters the data D3 to the data-stream processing unit 106. The data-broadcasting/EPG data processed in the data-stream processing unit 106 is then stored in the memory 107 via a bus 120 connected to the CPU 118 so as to be processed by a software program (to be described later) in the CPU 118, then stored at the hard disk 123.

The TS data is transferred in packets. A PID (Packet Identification) is added to the initial position of each packet. The demultiplexer 103 reads this PID so as to identify movie data D1, voice data D2, data-broadcasting/EPG data D3 respectively.

At first, a description will be made for movie data D1. The video decoder 104 decodes (MPEG2) the movie data D1 received from the demultiplexer 103 and outputs the decoded movie data to the display-control unit 109. The display-control unit 109 then changes and/or multiplexes screens according to a signal from the video decoder 104 or a key operation of the remote control device 116 so as to enable the image display 112 to display images. The screen composition unit 108 will be described later. The image display 112 is provided with a monitor screen (not shown) and a movie signal input terminal.

Next, voice data D2 will be described. The audio decoder 105 decodes (MPEG2) the voice data D2 received from the demultiplexer 103 and outputs the decoded voice data to the DAC 110. The DAC 110 then converts the voice data received from the audio decoder 105 from digital to analog and outputs the analog voice data to the voice-output unit 113. The voice-output unit 113 is provided with a speaker (not shown) and a voice signal input terminal.

Next, data-broadcasting/EPG data D3 will be described. The electronic program guide (EPG) data is transferred in the data structure regulated by the standards including “Program Exhibition Information Used for Digital Broadcasting”, etc. of Association of Radio Industries of Businesses (commonly known as ARiB). The main data items in the data structure are SDT (Service Description Table) for transferring target-channel-related information such as the name of a target channel, the name of a broadcasting company, etc., EIT (Event Information Table) for transferring program-related information such as the name of a program, the date and time for starting the broadcasting, the contents of the program, etc.

In the case of data-broadcasting, the DSM-CC data Carousel system regulated by ISO/IEC13818-6 is used to send digital data repetitively. Data-broadcasting data filtered by the demultiplexer 103 includes text information, script information, image information, and movie/voice data. The text information is described with the XML (extensible Markup Language) regulated by the W3C.

The data broadcasting/EPG data D3 is decoded by the data-stream processing unit 106 to EPG data consisting of text information and image information and data-broadcasting data that consists of text information, image information, and movie/voice data, then stored at the hard disk 123.

The CPU 118, when receiving a data-broadcasting display command from the remote control device 116 via the control unit 114 or light-receiving unit 115, reads the XML data for a display from the hard disk 123 and outputs the data to the screen composition unit 108.

The screen composition unit 108 outputs movie signals to the display-control unit 109 according to the data processed by the CPU 118. The display-control unit 109 then changes movie and/or data-broadcasting screens as described above and outputs movie signals to the image display 112 so as to display composite data.

The bus 120 is further connected to an IEEE1394 interface 122 and a modem. The IEEE1394 interface 122 is used for protocol communications between this TV receiver and a VTR 131 and/or a printer 132 that are both provided outside. The modem 121 is used to connect the TV receiver to the Internet via a telephone line.

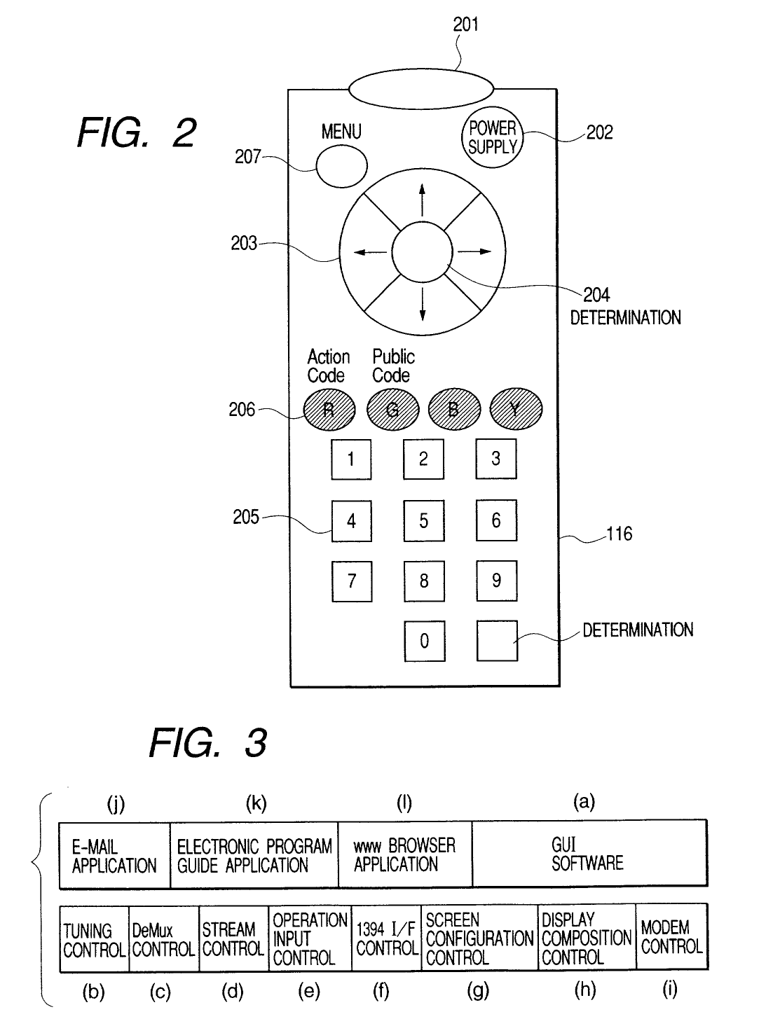

FIG. 2 shows an example of the remote control device 116. Note that, however, the remote control device 116 is provided only with minimum buttons required to execute the necessary functions of this embodiment. All the buttons required for an actual TV receiver are not illustrated here.

In addition to those shown in FIG. 2, such a pointing device as a mouse or the like may also be used.

In FIG. 2, reference numeral 201 denotes a light-emission unit used for the infrared beam communication between the remote control device and a light-receiving unit 115. Reference numeral 202 denotes a power key used to turn on/off a power supply and reference numeral 203 denotes cursor keys used to move the cursor up/down and to the right/left. Reference numeral 204 denotes a decision button used to decide a selected area specified by the cursor. Reference numeral 205 denotes a ten-key pad used to enter channel numbers and/or values. Reference numeral 207 is a menu button used to display the menu screen. Reference numeral 206 denotes four buttons referred to as color keys that are arranged from left; “Red”, “Green”, “Blue”, and “Yellow”. At the side of the “Red” key is printed “Action Code”. At the side of the “Green” key is printed “Public Code”.

The CPU 118 provided with a program execution unit controls the tuner unit 101, the descrambler 102, the demultiplexer 103, the decoder units 104 to 106, the screen composition unit 108, the display-control unit 109, and the DAC 110 according to the key operation of the control unit 114 or remote control device 116 provided with such operation switches as POWER ON, etc.

FIG. 3 shows a configuration of the control software programs to be executed in the CPU 118.

In FIG. 3, the GUI software program (a) is the core of the signal processings in this embodiment. Each of the control software programs (b) to (i) are interface software programs (drivers) for controlling each processing circuit shown in FIG. 1. The software programs (j) to (1) are application programs used to execute the above-described various functions.

Hereunder, a description will be made for the operation of the digital TV receiver in this embodiment with expectation of receiving “data-broadcasting news” consisting of character information, image information, and movie/voice information.

At first, data-broadcasting data used in this embodiment will be described.

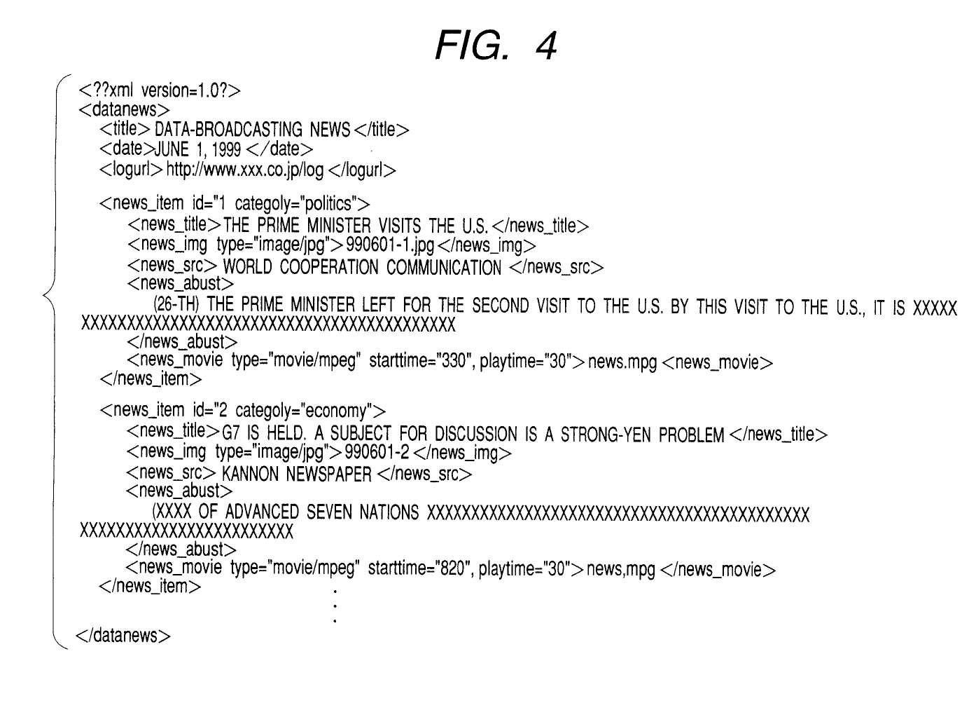

FIG. 4 shows an example of receiving XML data.

In this embodiment, the TV receiver receives XML data that includes more than 20 news items. However, FIG. 4 shows only two news items extracted from those so as to simplify the description. In the XML data, a tag (a part enclosed between <xx> and </xx>) is added to each character string so as to denote the attribute (to define the significance). For example, an attribute entitled as <title> is given to a character string of “data-broadcasting news”. This tag can take a “nesting” structure. For example, a tag <news title> </news title> can be included in a portion enclosed between <news item> and </news item> shown in FIG. 4.

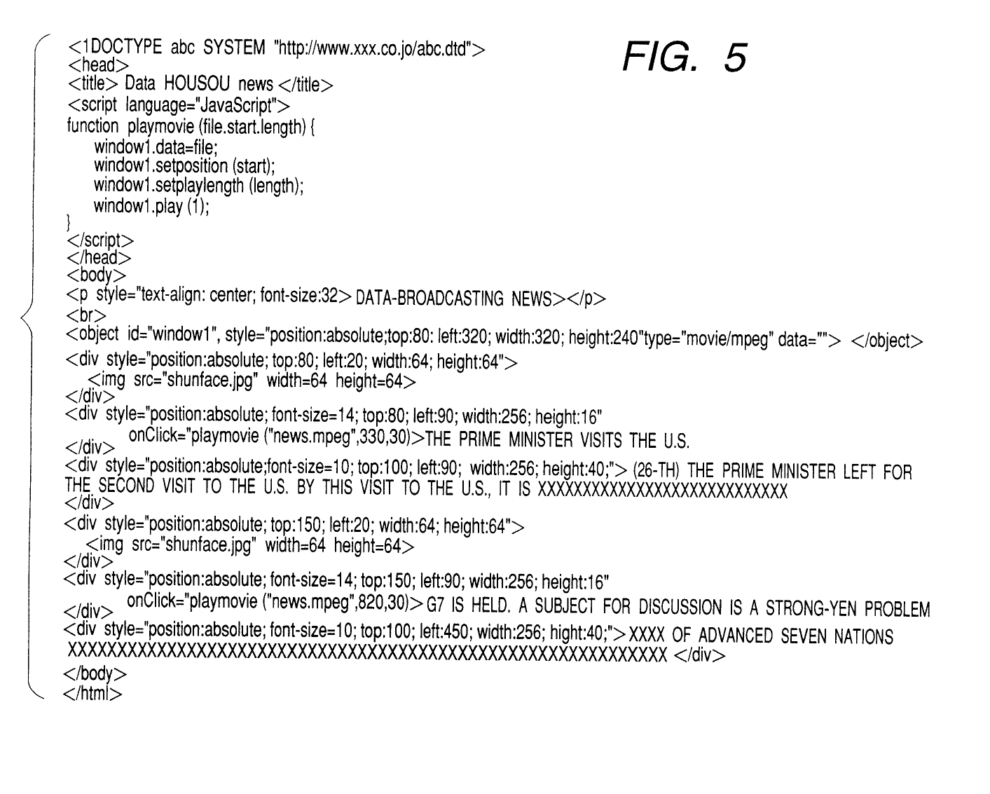

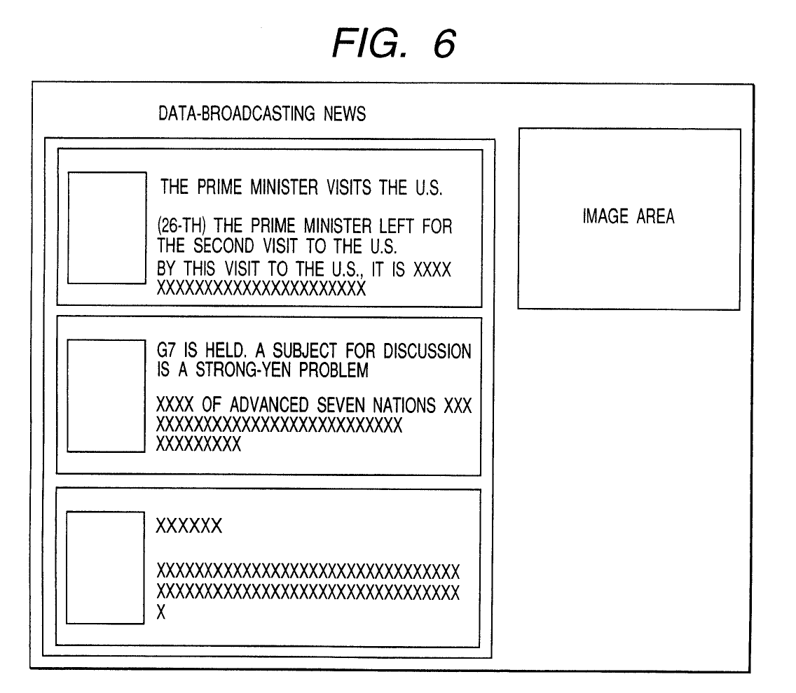

When displaying this receiving XML data on a screen, the XML data is converted to XML data for a display by the XML conversion program included in the GUI software program. In this embodiment, the XML data for a display uses the XML specifications decided on the basis of the HTML, which is obtained by re-formulating the HTML4.0 in XML1.0. FIG. 5 shows an example of the XML data for a display generated by an XML conversion processing. FIG. 6 shows an example for displaying this receiving XML data on a screen.

The screen displays three news items. Each news item includes a title, a photo, and a news abstract. In the XML data for a display as shown in FIG. 5, an “onclick” attribute is given to the area tag <div> that includes a news title. This means that the script function denoted by this attribute should be executed when the user selects this title area with use of the cursor, etc. and presses the decision key (or clicking the mouse pointer on the item). In this example, a script function “playmovie” is executed together with an argument of (news.mpeg,330,30).

According to this script function, a movie is reproduced in a specified window on a screen is reproduced for a specified period, starting at a specified portion. Concretely, when the user selects and decides a news title with use of the cursor, the movie file named as “news.mpeg” is reproduced in the specified window during 30 sec in 330 sec from the beginning portion. This embodiment employs the JavaScript, which is a script language used widely for home pages, etc.

In this embodiment, not only such the data-broadcasting data displayed on the screen, but also each news item are printed out on paper by a printing processing so as to make it easier for the user to read the character information. Next, this processing will be described in detail with respect to the operation of the CPU 118.

<Receiving and Storing Data-broadcasting Data>

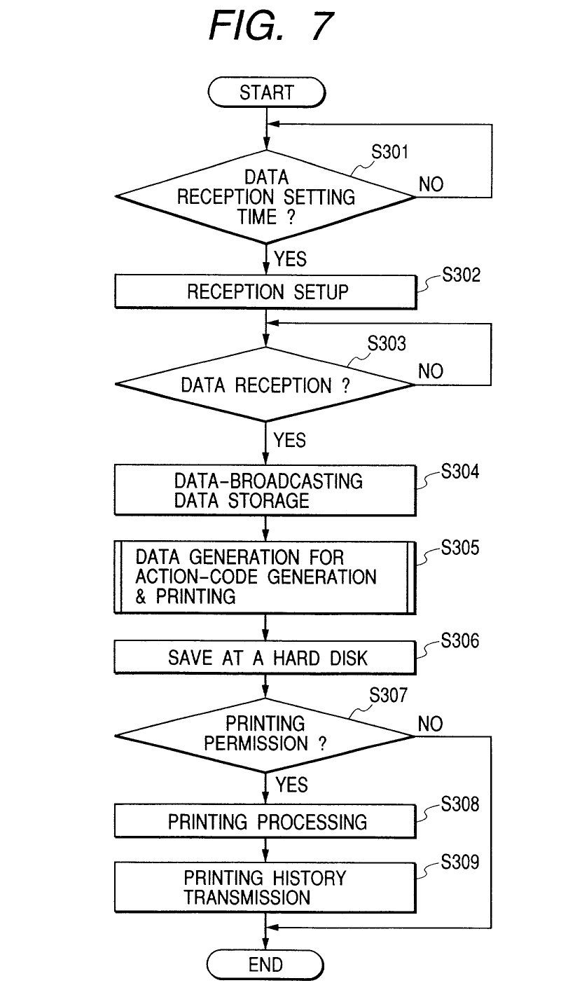

FIG. 7 shows a flowchart for describing the operation of the CPU 118 (system) for receiving data-broadcasting data in this embodiment.

In step S301, the system (CPU 118) decides whether or not a preset data-broadcasting receiving time is reached. When the decision result is YES, the system goes to step S302. In this case, the user can preset the data receiving time; for example, the user can preset the receiving time while he/she watches the electronic program guide (EPG).

The system then controls the tuner unit 101 for tuning in step S302. When the system receives data-broadcasting data via the descrambler 102 and the demultiplexer 103 in step S303, the data-stream processing unit 106 decodes the received data to XML text information, image information, and movie/voice data in step S304. The decoded image information and movie/voice data are then stored at the hard disk 123 and the XML text information is stored in the memory 107. Hereinafter, such the XML text information will be referred to as receiving XML data.

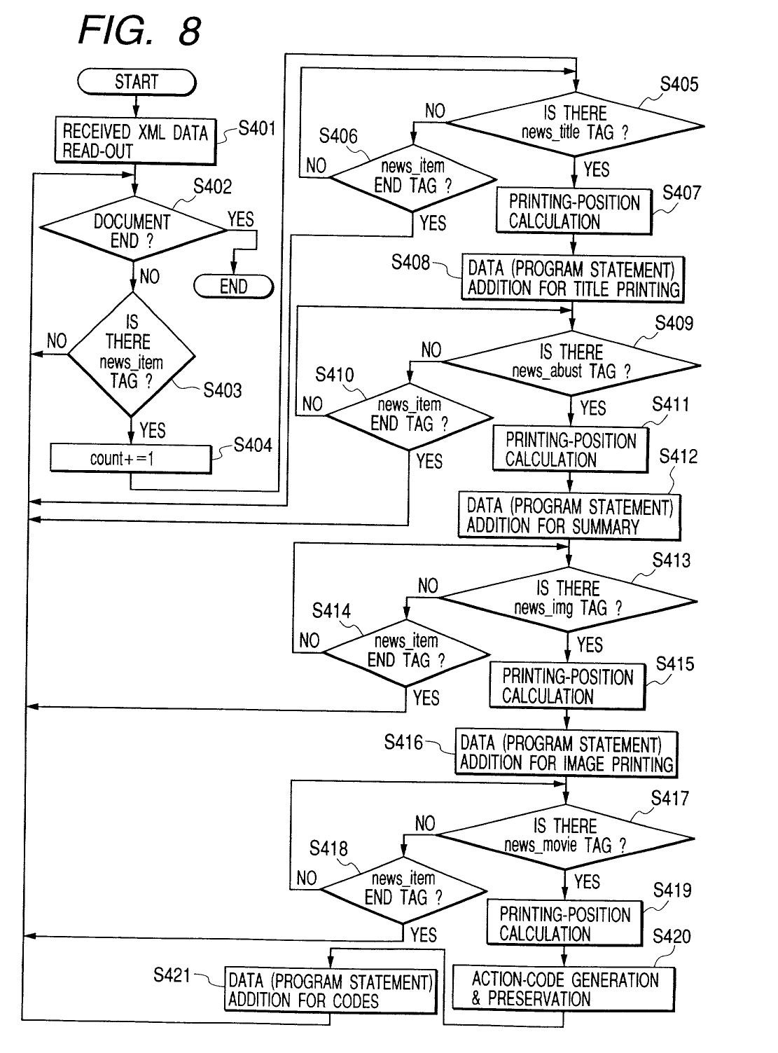

In step S305, the system generates an action code and converts the receiving XML data to XML data for printing (generation of action code and XML data for printing). FIG. 8 shows a flowchart for describing the details of this processing executed in step S305 shown in FIG. 7.

Reading the receiving XML data from the memory 107 in step S401, the system searches a <news item> tag in step S403. When the tag is found, the counter value is increased by one in step S404 (although the initial value is not shown, it is assumed as 1). The system then searches the content of the “news item” tag, that is, the <news title> tag in the data stored until </news item> appears in step S405. When the system finds the <news title> tag, the system calculates a printing position in step S407. The following expression A is used for calculating the printing position.

Equation A:

Title(X,Y,W,H)=(80+280*(count %3),100+100*(count/3),200, 20);

The system then adds the data denoting such attributes as a title printing tag, the display position, etc. (hereinafter, to be referred to as a program sentence) to the XML data for printing.

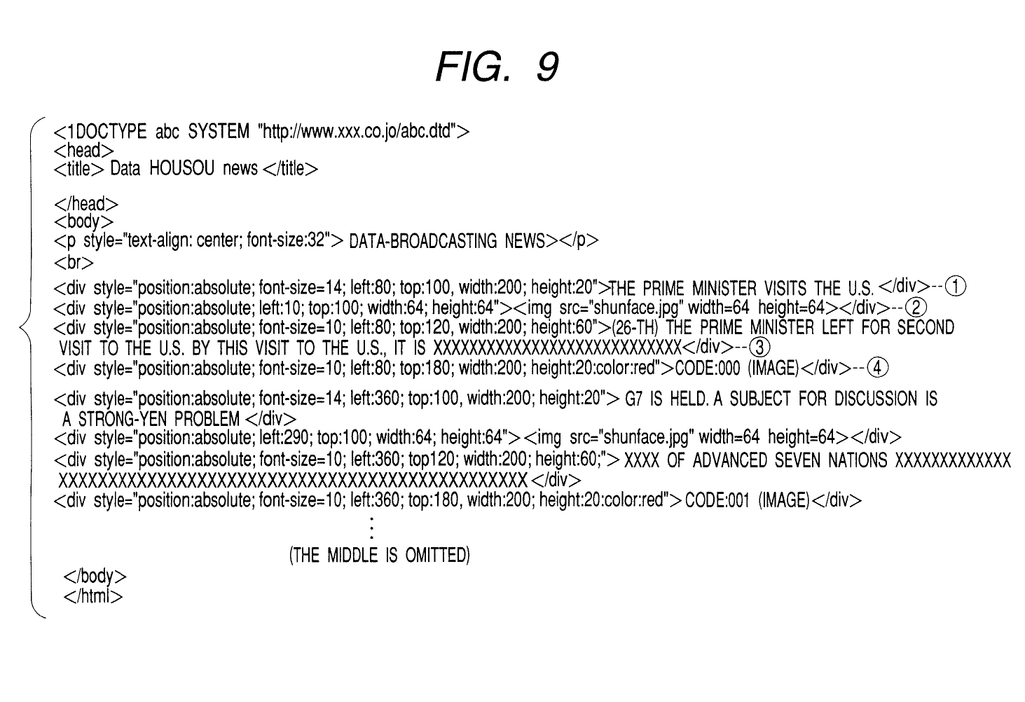

FIG. 9 shows the contents of the XML data for printing output in a processing shown in this flowchart. The line (1) in FIG. 9 is added to the program sentence in step S408. A program sentence is information added to text information as a markup. The added information includes printing position information, print character size information, etc. In this embodiment, the above-described XML tag that includes a style attribute is used as a markup.

Then, the system searches a <news abust> tag in step S409. When the tag is found, the system calculates a printing position in step S411. The following expression B is used for calculating the printing position.

Equation B:

Abust(X,Y,W,H)=(80+280*(count %3),100+20+100*(count/3), 200,60);

Then, a program sentence ((3) shown in FIG. 9) is added to the XML data for printing in step S412. The program sentence includes such attributes as a summary printing tag, a display position, etc.

After this, the system searches a <news img> tag in step S413. When the tag is found, the system calculates a printing position with use of the following expression C in step S415.

Equation C:

Image(X,Y,W,H)=(10+280*(count %3),100+100*(count/3),64, 64);

Then, the system adds a program sentence ((2) shown in FIG. 9) to the XML data for printing in step S416. The program sentence includes such attributes as an image printing tag, a display position, etc.

The system then searches a <news movie> tag in step S417. When the tag is found, the system calculates a printing position with use of the following expression D in step S419.

Equation D:

Code(X,Y,W,H)=(80+280*(count %3),100+80+100*(count/3), 200,20);

Furthermore, the system generates an action code in step S420. In this embodiment, a 3-digit number is used for each action code; a number within 000 to 999 is assigned sequentially to each action information. After 999, 000 is assigned cyclically.

Generating an action code, the system reads the attribute data (type=movie/mpeg and starttime=“330”, etc.) of the <news movie> tag and the content of the news.mpeg” tag and stores the data together with the action code in the memory 107. An example of the data to be stored in the memory 107 at this time is as follows.

action_code=000,type=“movie/mpeg,data=“news.mpeg”, starttime=“330”,playtime=“30”;

action_code=001,type=“movie/mpeg,data=“news.mpeg”, starttime=“820”,playtime=“30”;

In step S421, the system adds a program sentence ((4) shown in FIG. 9) to the XML data for printing. The program sentence includes an action code printing tag and such attributes as a display position, etc.

In this embodiment, action codes are printed out in red.

The XML data for printing generated in the above processing is stored at the hard disk 123 in step S306 shown in FIG. 7.

In the case where immediate printing is enabled in step S307 , printing is started according to the XML data for printing described above. The user can set whether to enable/disable this immediate printing. In the case where the user disables immediate printing, the user can start printing with use of the remote control device. In this embodiment, it is premised that the immediate printing is enabled.

The system converts the XML data for printing to bit map data for printing with use of the layout, font, and color set respectively according to the style set in the printing processing in step S308, then sent to the object printer. In the case where image data is included in the printing data, the image data is read from the hard disk 123, then converted to a bit map.

Bit map data for printing is output to the printer 132 via the IEEE 1394I/F 122. When the printing is started, the system sends a “printing log” to the host on the Internet in step S309. This “printing log” will be described later.

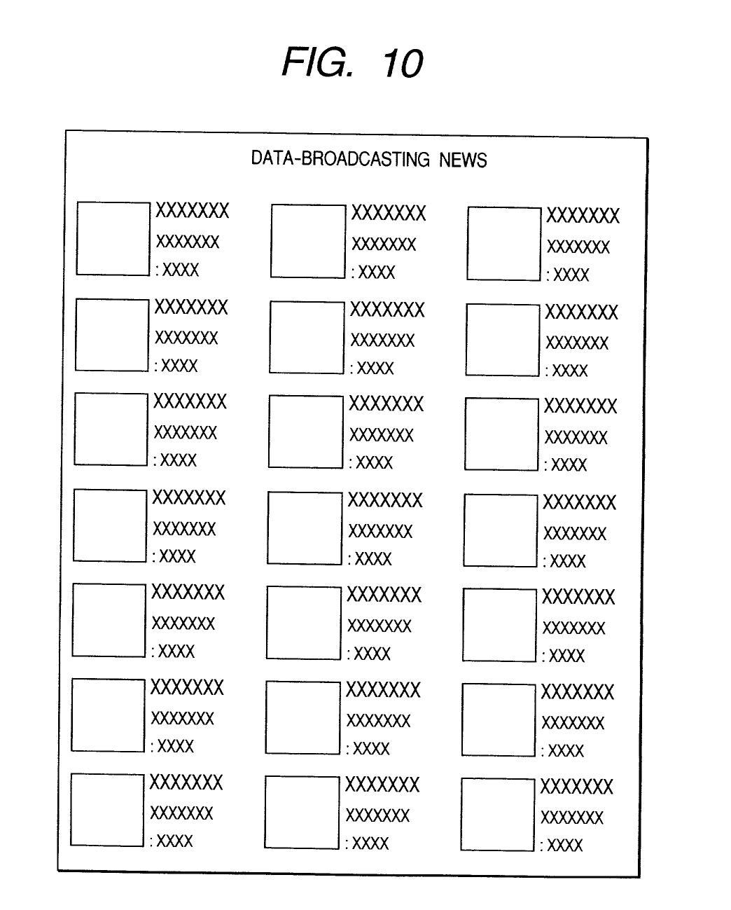

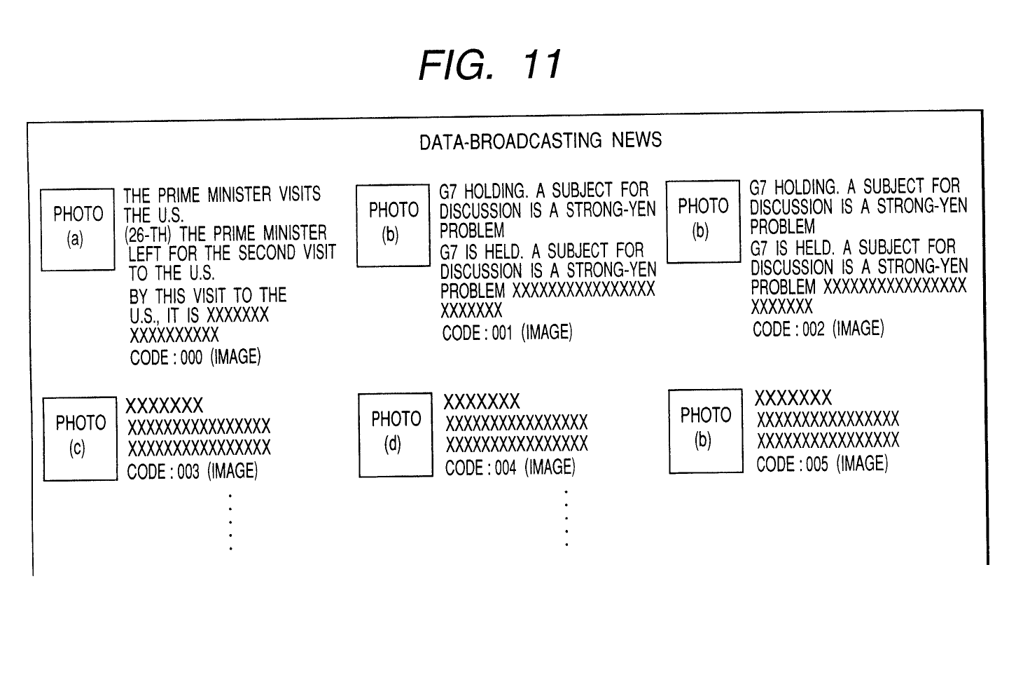

FIGS. 10 and 11 show examples of the results of the printing in this embodiment. FIG. 10 shows an entire printed form and FIG. 11 shows an expanded view of the printed form. In this example, 21 news items (titles, images, and summaries) are printed out on an A4-size form. An action code (CODE: xxx) is printed out for each of those news items.

<CPU Operation for Watching the TV>

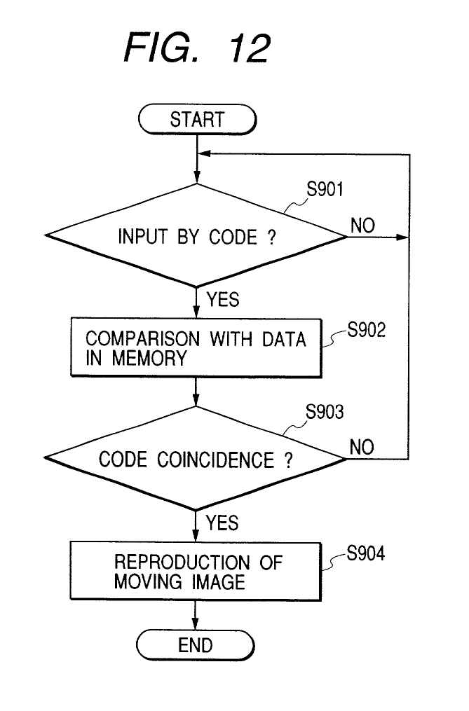

Next, a description will be made for the system (CPU 108) operation when the user watches a data-broadcasting program during an actually printed form check. FIG. 12 is a flowchart for describing such the processing.

In the case where the user enters an action code while he/she refers to a printed form shown in FIGS. 10 or 11 in step S901, the system checks whether or not the entered action code coincides with that stored in the memory 107 in the above-described processing in step S902. When the decision result is YES, the system reproduces the movie data in step S904. For example, in the case where the user enters a code “000”, the system reproduces the movie data from the “news.mpeg” file stored at the hard disk 123 for 30 seconds, starting at the 330th-second movie data.

In order to enter an action code, the user is requested to press the action code (red) button of the remote control device 116 shown in FIG. 2, then enter the three-digit code. While the remote control device 116 used in this embodiment is also provided with other keys, correspondence is assumed between the “red” button on the remote control device 116 and the action code printed in “red” on the form. The user will therefore be prevented from confusion in key operation.

<Printing Log>

In this embodiment, each time a printing processing is done, a “printing log” is sent to the host on the Internet. For example, the following information is sent as a printing log to the host on the Internet.

“Printlog 1:data=shop.jpg, 1999April24 UserID=######”

The system (CPU 118) controls the modem 121 so as to connect it to a predetermined host and send the above information to the host. The host may be operated by any of a TV broadcasting station and a programming company. In the case where the host is operated by such a programming company, the information of access to the host must be described in the data-broadcasting program. In FIG. 4, the <logurl> tag is such the information of access to the host.

When such a printing log is sent to the host as described above, the contents provider can know what kinds of information are passed to the subject user. Such a printing log is also used to provide, for example, an ink or toner cartridge and/or print paper extra free of charge to the users who have made many printing processings.

The expressions for calculating printing positions so as to specify a printing layout may be stored in the body of the apparatus in this embodiment, for example, by installing such software programs as a printer driver, etc. therein.

[Second Embodiment (Bit Map Data Broadcasting)]

While XML data received in data-broadcasting is converted so as to generate print data, thereby providing each user with a user interface that enables the user to watch data-broadcasting more easily in the first embodiment as described above in detail, the data-broadcasting form is not limited only to that; a broadcasting station may send print data to the TV receiver from the start. The present invention can provide users with an environment under which they can enjoy watching of such the data-broadcasting easily. Hereinafter, an example for watching such the data-broadcasting will be shown.

The configurations of the TV receiver, the remote control device, and the software programs used in this embodiment are the same as that of the first embodiment shown in FIG. 1 and that of the remote control device shown in FIG. 2, and that of the software structure shown in FIG. 3. The description for each component in this embodiment will thus be omitted.

<Processings from Receiving to Printing Out>

Hereinafter, a description will be made for the operation of the digital TV receiver in this second embodiment on the assumption that a shopping program is broadcast by data-broadcasting.

<About the Data-broadcasting Format>

It is premised that this shopping data-broadcasting is composed of print data for printing a products catalog consisting of characters, images, etc.; XML data for displaying each product information on a display screen; and such data as image data and voice data including movie images for introducing each product. The print data for printing a products catalog is configured by a corresponding data string on each print sheet. Each data string includes data for photos, descriptions, product codes, etc. for a plurality of products.

<Receiving and Storing Data-broadcasting Data>

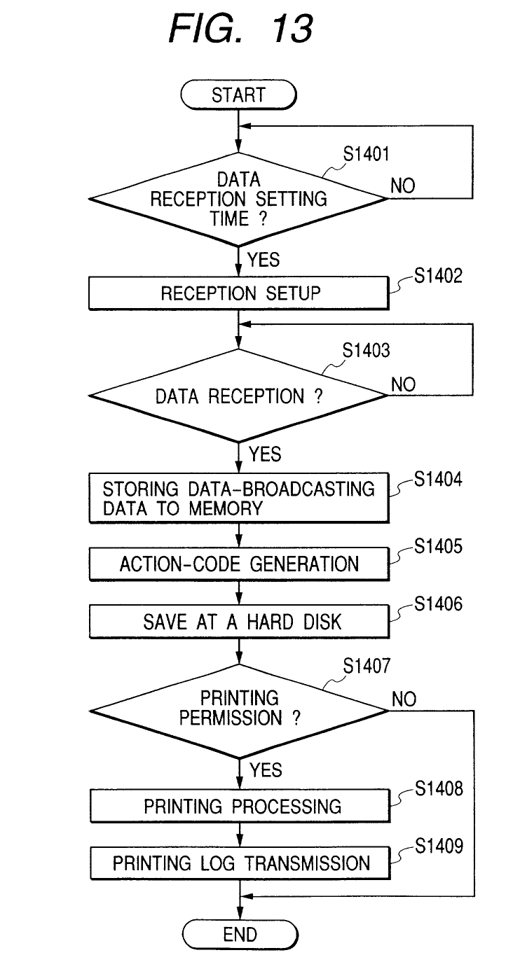

FIG. 13 shows a flowchart for describing the operation of the CPU 118 (system) for receiving data-broadcasting data.

In step S1401, the system decides whether or not a preset data-broadcasting receiving time is reached. When the decision result is YES, the system goes to step S1402. In this embodiment, the user can preset such a data receiving time. For example, the user can set the receiving time while he/she watches the electronic program guide (EPG).

The system then controls the tuner unit 101 for tuning in step S1402 so as to start receiving of data-broadcasting data via the descrambler 102 and the demultiplexer 103 in step S1402. The system then controls the data-stream processing unit 106 so as to decode the received data to XML data for a display, print data, and movie/voice data in step S1404, then stores the print data and the movie/voice data at the hard disk 123 and the XML text information in the memory 107.

Then, the system generates an action code in step S1405. In this embodiment, a unique action code is assigned to each print and data-broadcasting data is displayed in correspondence to each print in response to an entered action code.

The system stores the tag denoting a data string corresponding to each print in the print data stored at the hard disk 123 and an action code in the memory 107 in which both tag and action code are corresponded to each other.

Furthermore, the generated action code is related to the file name of the XML data for a display corresponding to each print, then stored in the memory 107. For example, the following information is stored in the memory 107.

action_code=000,type=“text/xml,data=“shop.xml”

The action code “000” denotes that the “shop.xml” file that stores text information set in the XML data for a display is read and displayed.

In this embodiment, a three-digit number is used for each action code. A serial number within 000 to 999 is assigned sequentially to each action information. After “999”, “000” is assigned cyclically.

In step S1406, the XML data for a display stored in the memory 107 is transferred to and stored at the hard disk 123.

In the case where immediate printing is enabled, the system starts the printing according to the print data in step S1407. The user can preset enabling/disabling such the immediate printing beforehand. In the case where immediate printing is disabled, the user can start the printing later with use of the remote control device. In this embodiment, it is premised that immediate printing is enabled at this time.

In the printing processing in step S1408, the system outputs bit map data for printing to the printer 132 via the IEEE 1394I/F 122. The system generates this bit map data according to the action code corresponding to each print read from the memory 107 and the print code read from the hard disk 123.

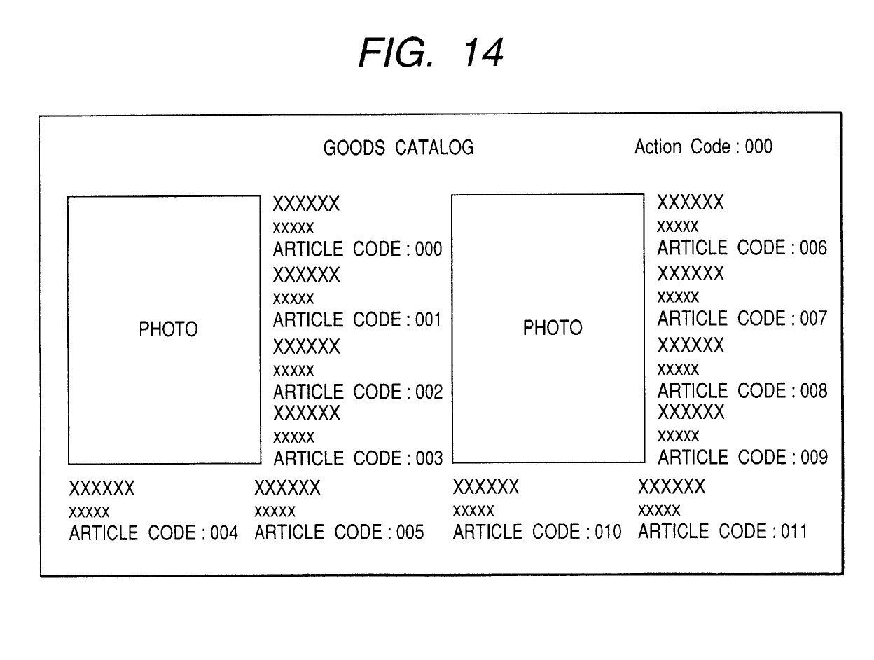

FIG. 14 shows a result of this printing. In this example, two photos are printed out on an A4 form and names, descriptions, codes of a plurality of products in those two photos are described around those photos. In the upper right portion of the form is printed out the action code generated in the previous processing.

<Processings for Watching>

Hereinafter, a description will be made for the operation of the user to be executed for watching a data-broadcasting program.

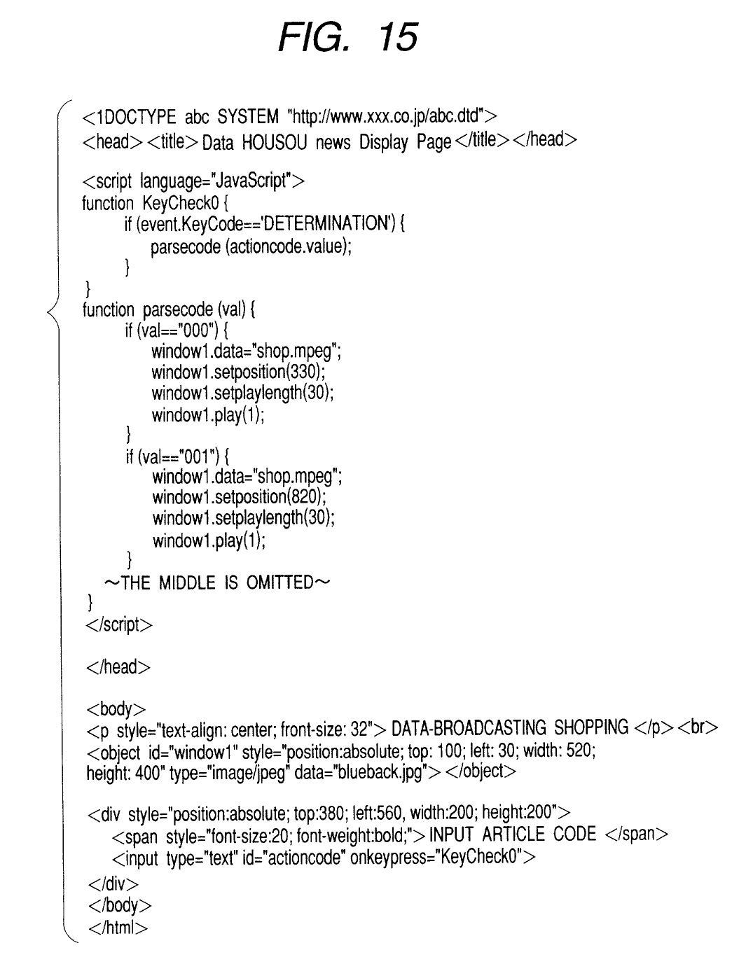

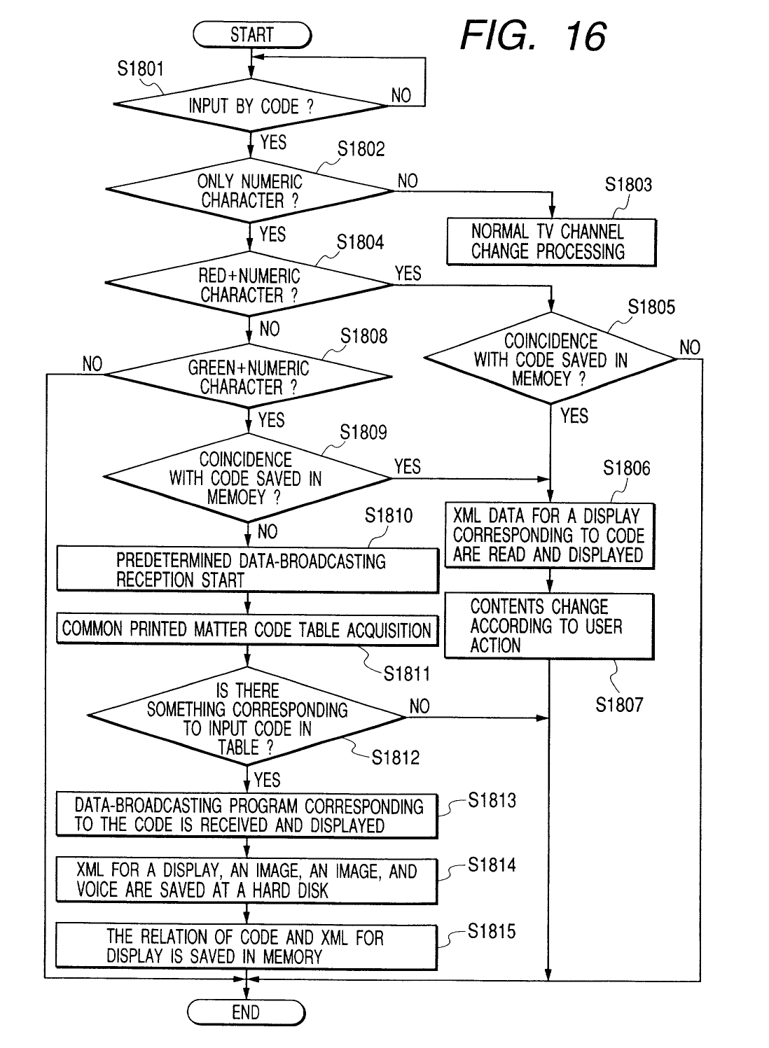

In the case where the user presses the red key (hereinafter, to be referred to as the action code button) and numeric keys on the remote control device while he/she watches an ordinary TV program, the system reads the XML data for a display corresponding to the action code and displays the data on the screen. FIG. 15 shows such the XML data displayed on the screen. FIG. 16 shows a flowchart for describing controlling of the processing.

In the case where the system recognizes an action code entered by the user in step S1801 shown in FIG. 16, the system decides whether the user has entered only numbers or the action code button+numbers in step S1802. In the case where only numbers are entered, the system regards the code entry just as selection of an ordinary TV channel in step S1803.

On the other hand, in the case where the action code button+numbers are entered, the system decides whether or not the data includes an action code that coincides with the action code entered (in step S1805). In the data, the action code stored in the memory 107 and XML data for a display are corresponded to each other. When the decision result is YES, the system reads the corresponding XML data for a display from the memory 107 and outputs the data to the image display 112(step S1806).

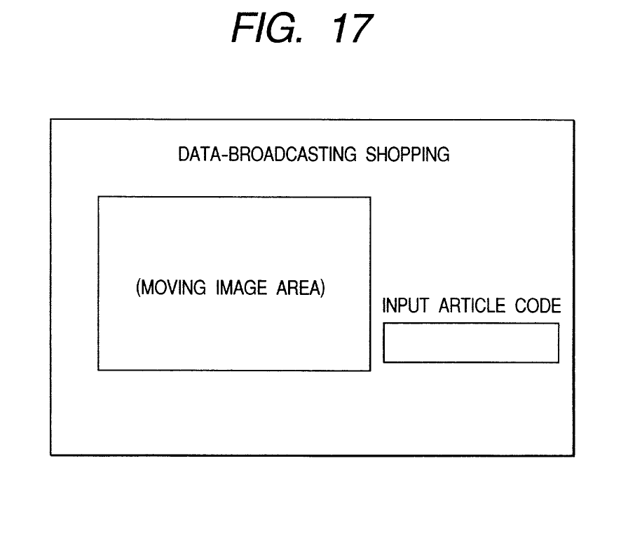

FIG. 17 shows the XML data for a display displayed on the screen at that time. Because a script is described in the XML data for a display in this example, the user can enter a product code while watching the screen shown in FIG. 17. Then, the product introduction image corresponding to the product code is displayed in the “movie area” shown in FIG. 17.

Such way, the user can go to a data-broadcasting screen as shown in FIG. 17 easily just by entering the action code button and numeric keys even while he/she watches an ordinary TV program. While it has been difficult to know the correspondence between content (display screen) and print when many product catalogs are printed out in the conventional technique, this embodiment makes it easier for the user to watch data-broadcasting just by entering this action code, since a unique action code is printed out for each received print data.

<Correspondence to General Publications>

Although the digital TV receiver receives data-broadcasting and prints out the information while the user sees the print for an operation in the above description, the user may use general publications and prints such as magazines, advertisements, etc. instead of the data printed out by the digital TV receiver. The present invention also makes it possible for the user to watch data-broadcasting easily in such a case.

Next, a description will be made for the flowchart shown in FIG. 16 again.

In the case where the system recognizes a code entry in step S1801, the system then decides whether or not the code is just a number in step S1802. When the decision result is YES, the system sets a TV channel to be received in step S1803. When the decision result is NO (entry: action code button (red key)+a number), the system processes the entry as an action code just as described in step S1806.

After this, when the system regards the entry as the green key (hereinafter, to be referred to as the public code key)+a number in step S1808, the system checks whether or not the information related to the entered public code is stored in the memory 107 in step S1809. When the decision result is YES, the system goes to step S1806 so as to execute the same processing as the above one.

On the other hand, when the decision result is NO, the system controls the tuner unit 101, the descrambler 102, and the demultiplexer 103 in step S1810 so as to receive predetermined data-broadcasting data and obtain a general print code conversion table from the received data (step S1811).

This table shows the correspond between each general print code assigned to a general print and the date and time for starting related data-broadcasting and such receiving parameters as a broadcasting channel, etc. required to receive the data-broadcasting. The table is used for repetitive data-broadcasting via a predetermined channel. When a code coinciding with the entered public code is found in step S1812, a receiving parameter related to the public code is obtained in step S1813.

Furthermore, the system starts data receiving just after data-broadcasting is started according to the obtained receiving parameters in step S1813. In the case where data-broadcasting is not done at that time, the system stands by. The system then outputs received XML data for a display in the data-broadcasting to the image display 112, thereby the data-broadcasting data corresponding to the entered public code is displayed on the screen.

At this time, the system also stores the XML data for a display, still image data, and movie/voice data with respect to the received data-broadcasting at the hard disk 123 (step S1814) and the information that makes the entered public code correspond to the XML data for a display in the memory 107 (step S1815). The following is an example of the information on correspondence between each input code and XML data for a display stored respectively in the memory 107.

public_code=3243, info_magazine_{—}99Apr.xml

As described above, this embodiment makes it possible to reproduce and display still image data and movie/voice data related to the information printed on a form just with a very simple operation, which is an entry of a printed code. Such the simple operation is also possible even for data-broadcasting contents printed out on such general prints as magazines and newspapers just like data-broadcasting contents that must be printed out by a digital TV receiver.

Sometimes, there might occur any correspondence between a code assigned to a general print and a code assigned to an operation in the digital TV receiver. The present invention can avoid such a problem, since the remote control device, which is provided with color keys, assures the correspondence between each color key and the printed color of each print code or the printed color of each general print code. Inputs of wrong category codes can thus be prevented. For example, a general print code is printed in green in this embodiment. It is thus easy to distinguish between the general print code printed in green and an assigned “red” action code printed by the digital TV receiver of the present invention. The user will thus understand easily he/she is just requested to enter a “green” key+a code.

[Third Embodiment]

In the case where a plurality of users share a digital TV receiver, each user will often want to watch data-broadcasting contents that are different from those of others. It has thus been very complicated and troublesome for each user searches his/her desired contents. Under such circumstances, this third embodiment provides each of a plurality of users with the optimized information with respect to data-broadcasting contents and makes it possible for the user to watch such optimized data-broadcasting contents with a simple operation.

In the data-broadcasting data and the digital TV receiver in this embodiment, same reference numerals/symbols will be given to the same items as those in the first embodiment, avoiding redundant description.

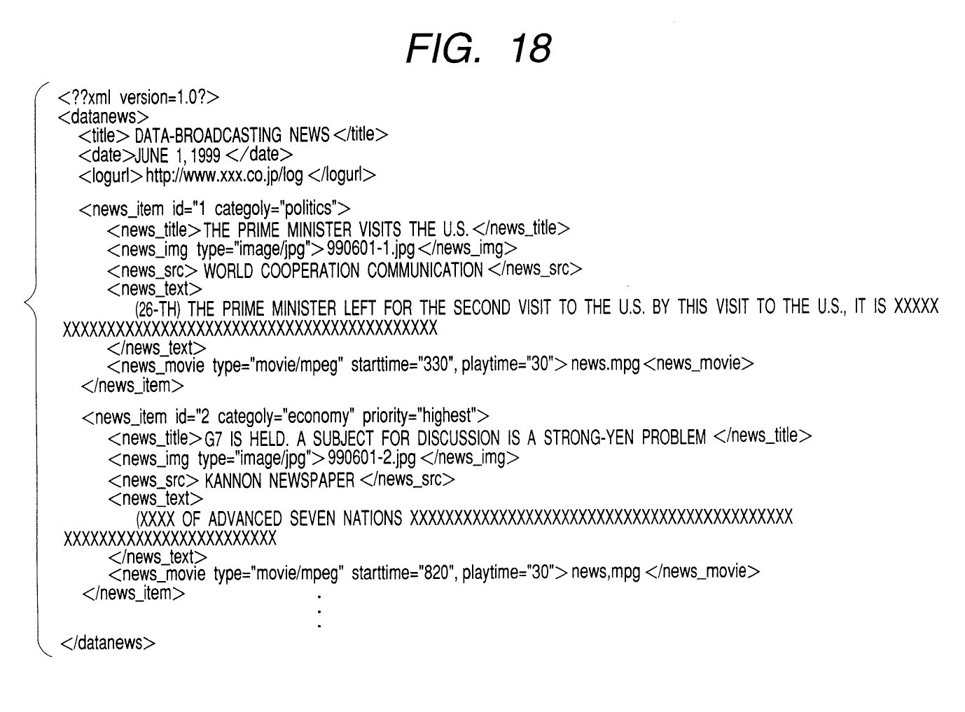

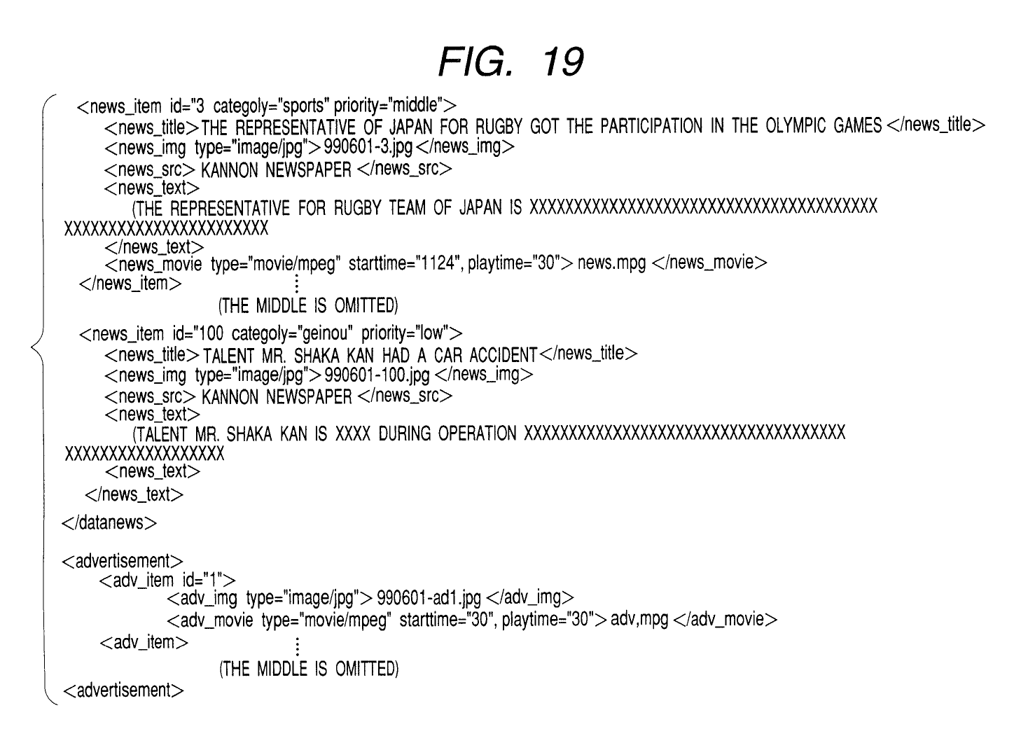

At first, FIGS. 18 and 19 show an example of receiving XML data in this embodiment. In this embodiment, each news item includes the title, the photo, the information source, the information obtaining date and time, the news category, the priority information, the related movie information, etc. thereof.

Next, a description will be made for each flowchart of concrete processings in detail from data-broadcasting receiving to printing in this embodiment.

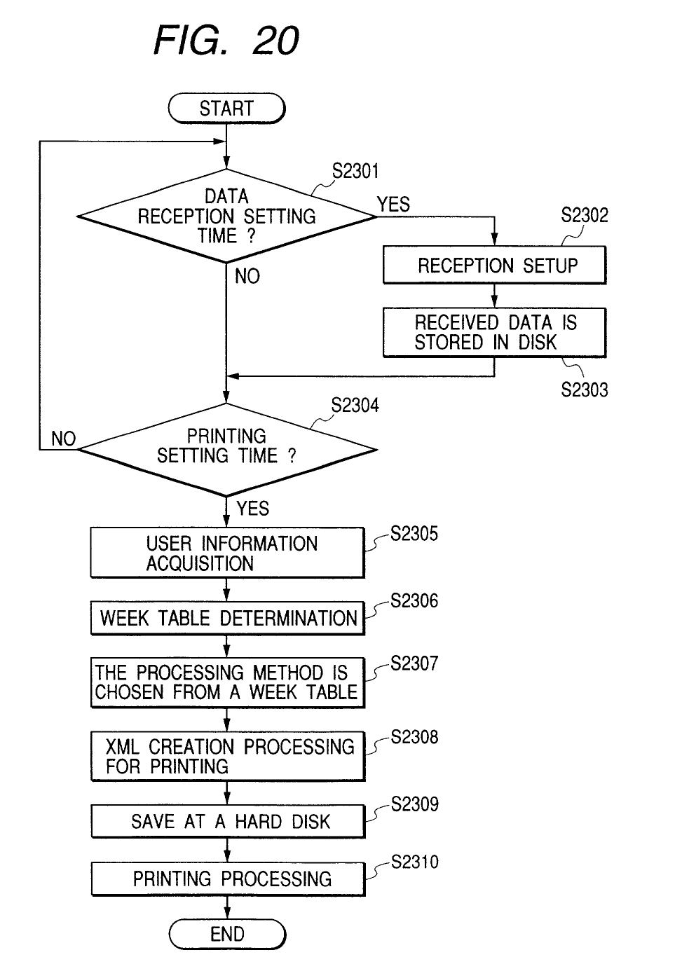

FIG. 20 shows a flowchart for describing the whole operation of the CPU 118 (system) from data-broadcasting receiving to printing. This flowchart describes only the printing of reserved data-broadcasting data at a reserved time; how to reserve the printing will be described later.

<Receiving and Storing Data-broadcasting Data>

The system decides whether or not a reserved data-broadcasting program receiving time (to be described later) is reached in step S2301. When the decision result is YES, the system goes to step S2302. In this embodiment, the user can preset such a data receiving time. For example, the user can set this receiving time by reserving printing of a desired data-broadcasting program while he/she watches the electronic program guide (EPG) as to be described later.

The system then controls the tuner unit 101 for tuning and starts fetching of the data broadcasting data reserved for printing via the descrambler 102 and the demultiplexer 103 in step S2302. Receiving the data, the system controls the data-stream processing unit 106 so as to decode the received data to XML text information, image information, and movie/voice data, then stores the decoded information and data at the hard disk 123 in step S2303. Hereinafter, this XML text information will be referred to as receiving XML data.

<Selecting Data from Receiving XML Data>

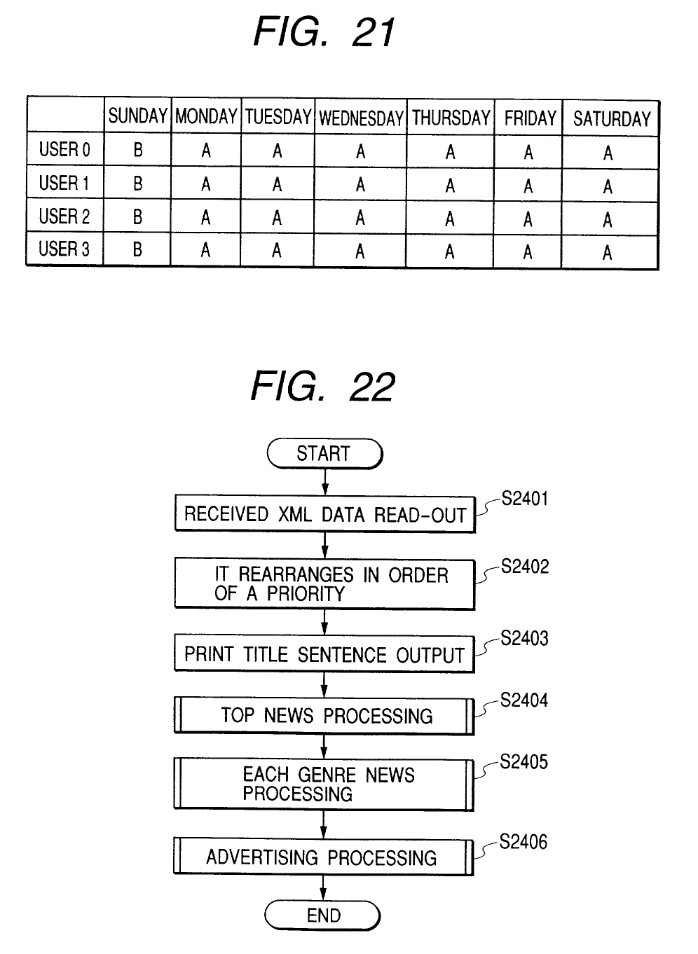

When a reserved printing time is reached in step S2304, the system reads the printing reservation setting information from the memory 107 in step S2305 so as to obtain the user information. The user information consists of four items; USER0, USER1, USER2, and USER3 that are tabulated as a weekly table as shown in FIG. 21.

The weekly table describes how to convert receiving XML data to XML data for printing on each day of the week from Sunday to Saturday with respect to each user. For example, the B processing method (processing B) is employed on Sunday and the A processing method (processing A) is employed on Monday respectively for USER0 shown in FIG. 21.

Furthermore, it is possible to preset both processing method and printing time for each user so as to be corresponded to a day of the week. The details will be described later. In the processings in the flowchart shown in FIG. 20, the processing method set for USER0 is employed as a default one.

The system obtains the subject information from the weekly table in step S2306. For example, for USER0, the system reads the information of Sunday: B and Monday: A from the weekly table shown in FIG. 21. Then, the system obtains the current day of the week so as to decide the processing method in step S2307.

<Creating XML Data for Printing: Processing A>

After this, in step S2308, the system converts receiving XML data to XML data for printing according to the processing method decided in step S2307.

FIG. 22 shows a flowchart for details of the “processing A”.

At first, the system reads the receiving XML data described above and stores the data in the memory 107 in step S2401. Then, the system rearranges all the news items included in the receiving XML data in order of their priority levels. Concretely, the system reads the priority attribute in the <news item> tag shown in FIGS. 4 and 5 and rearranges the news contents enclosed between <news item> and </news item> in the following order.

Highest>High>Midd1e>Low

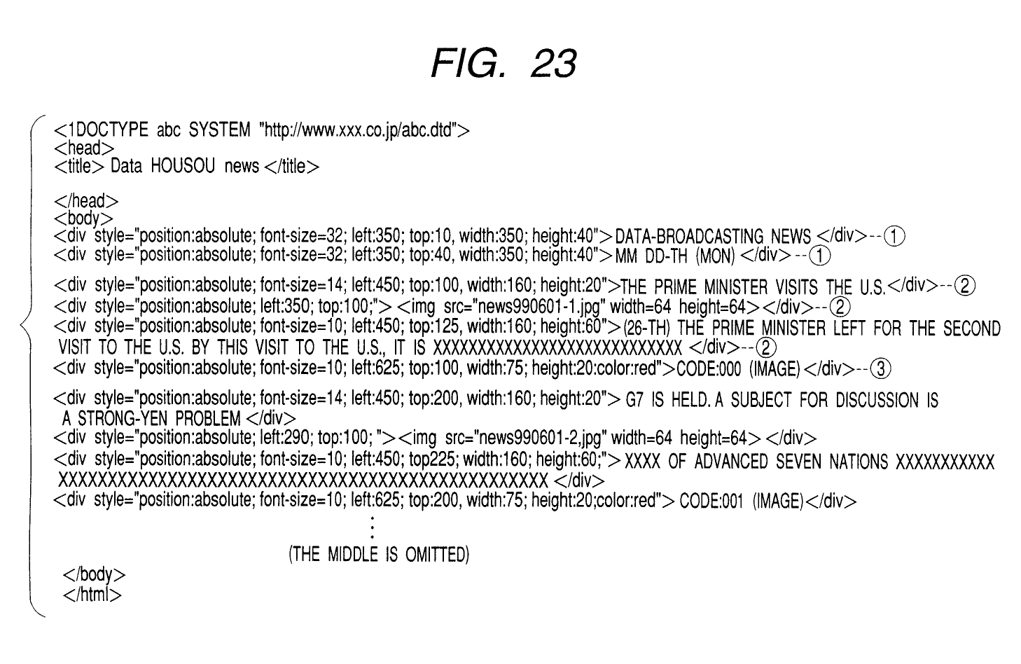

Then, the system adds (outputs) a program sentence for printing the tile of a print to the subject data string in step S2403. FIG. 23 shows an example of the XML data for printing created in this processing. The line (1) in FIG. 23 is the program sentence for printing the print title. A program sentence mentioned here means information added as markups to text information. The markups are, for example, printing position information, printing character size information, etc. required for the subject printing. In this embodiment, an XML tag that includes a style attribute is used as a markup.

After this, the system processes the top news to be printed out and outputs (adds) a program sentence for printing the top news to the XML data for printing in step S2404.

The system further outputs (adds) a program sentence for printing news items in each of the “politics, economy, international, society, sport, area, and entertainment categories” to the XML data for printing in step S2405. Then, the system outputs (adds) a program sentence for printing advertisement to the XML data for printing in step S2406.

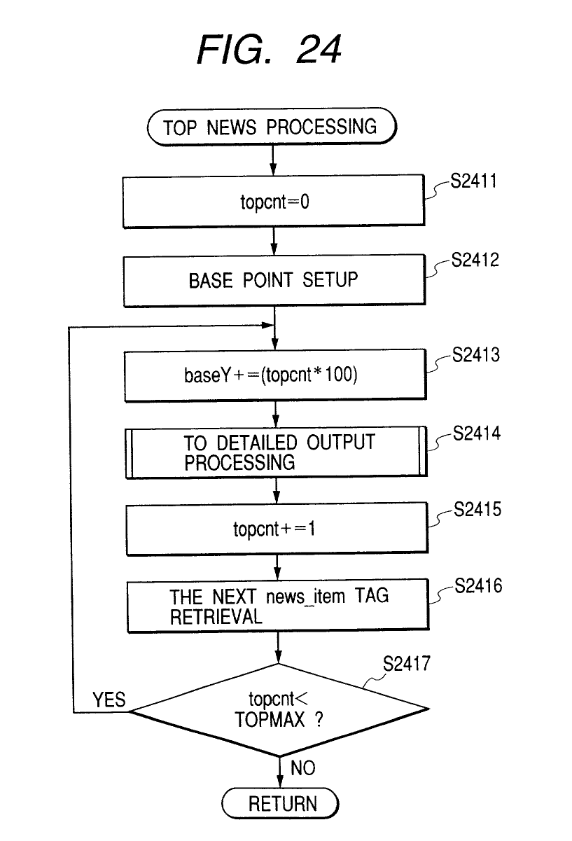

Next, a description will be made for a top news processing executed in step S2404 with reference to the flowchart shown in FIG. 24.

At first, the system searches a <news item> tag from the receiving XML data rearranged in order of their priority levels as described above and reads the first news item from the memory 107 and stores the data in a buffer area of the memory 107 temporarily in step S2410.

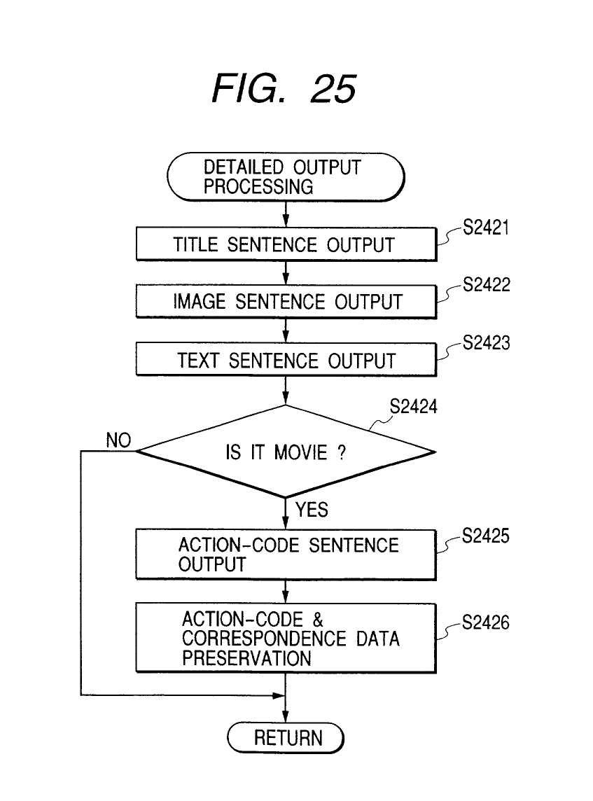

The system then initializes a variable for counting the number of top news items in step S2411. After this, the system reads the set value of a base point corresponding to each category, such as news/advertisement in each processing shown in FIG. 25 in step S2412. Then, the system specifies the base point as the first item position of the top news in the XML data for printing. In the processing A, a position denoted by the 350th point from the left and by the 100th point from the top on the form is assumed as the base point. In step S2413, the system adds an offset to the base point, then executes a detailed output in step S2414.

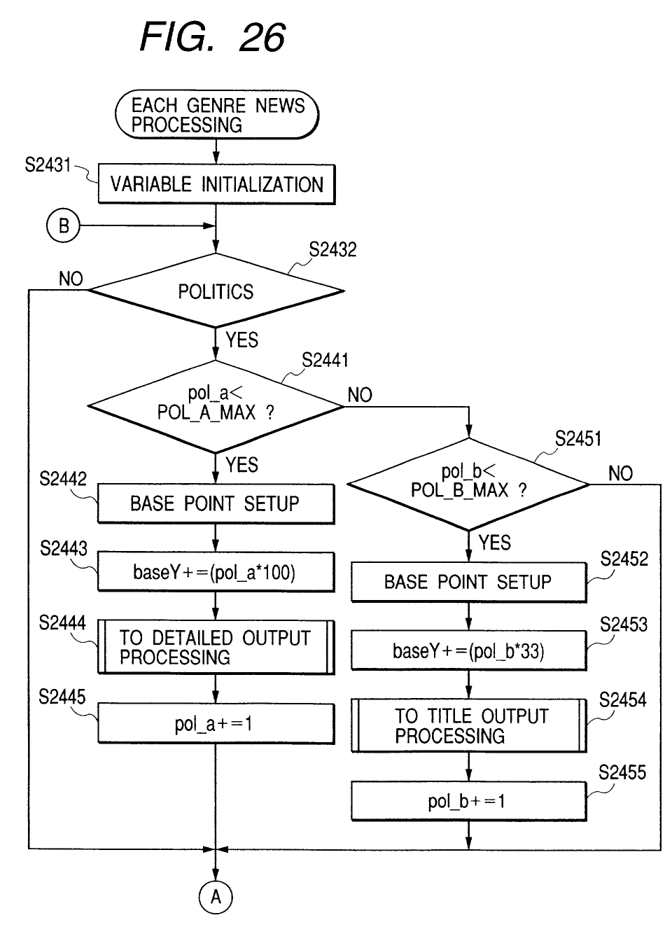

FIG. 26 shows a flowchart for describing the detailed output processing executed in step S2414.

In this detailed output processing, the system creates a program sentence for printing the title, the image (photo), and the text of each item of the top news according to the base point information and the data stored in the buffer area, then outputs (adds) a program sentence to an XML data string for printing (steps S2421 to 2423 in FIG. 26). When outputting each program sentence, the system calculates a position for printing each of the title, the image, the text, etc. specified by the program sentence with use of the following expressions A to C, thereby the position is affected in the program sentence for printing the news title as style information.

Equation A:

Title(X,Y,W,H)=(baseX×+100,baseY,160,20)

Equation B:

Image(X,Y,W,H)=(baseX,baseY,64,64)

Equation C:

Text(X,Y,W,H)=(baseX+100,baseY+25,160,60)

For example, the position of a news title is decided by the expression A and the “processing A” adds style information (left=450, top=100) to the XML data for printing, since base X=350 and base Y=100 are assumed. The sentences (2) shown in FIG. 23 are output examples. The expression B is used for calculating a position for printing an image (photo) and the expression C is used for printing a text.

The system then checks whether or not the XML data includes a <news movie> tag in step S2424. When the result is YES, the system generates an action code in step S2425 and outputs a program sentence for printing the action code together with the position information calculated in the following expression D, the content of the “movie” action, and the text denoting the action code.

Equation D:

Code(X,Y,W,H)=(baseX+275,baseY,75,20)

In this embodiment, a three-digit number within 000 to 999 is used for each action code. Each time a number is assigned to an action code, the counter value is increased by one. After 999, the counter value returns to 000 cyclically. The line (3) in FIG. 23 is an output example for that. The system stores this action code and movie information (content of the <news movie> <news movie> tag) in the memory 107 so that they are corresponded to each other there. The system transfers the file data (movie image data) stored in a file denoted by the movie information to the hard disk 123 so as to be stored there.

Terminating the detailed output processing, the system returns to the flowchart shown in FIG. 24 and adds “1” to the value in the top news count variable in step S2415, then searches the next news tag and stores the tag in the buffer area described above in step S2416.

The system then decides in step S2417 whether or not the maximum number of printing items of the top news (TOPMAX) is under a predetermined value. When the result is NO, the system returns to step S2413. When the result is YES, the system goes to step S2405 in FIG. 22. In this embodiment, the maximum number of printing items of the top news is set to 3 for the processing A.

When the value in the news count variable is under 3 in step S2417, the system returns to step S2413 so as to process the information of the next top news item just like in the processing described above. In this case, note that the position of style information included in each of the program sentences for printing out the title, the image, the text, and the action code takes a value to which 100 is added with respect to the next news item, since 100 is added to the baseY variable in step S2413.

When the system outputs (adds) the program sentences for printing three top news items such way, the system processes each category news processing in step S2405 in FIG. 22.

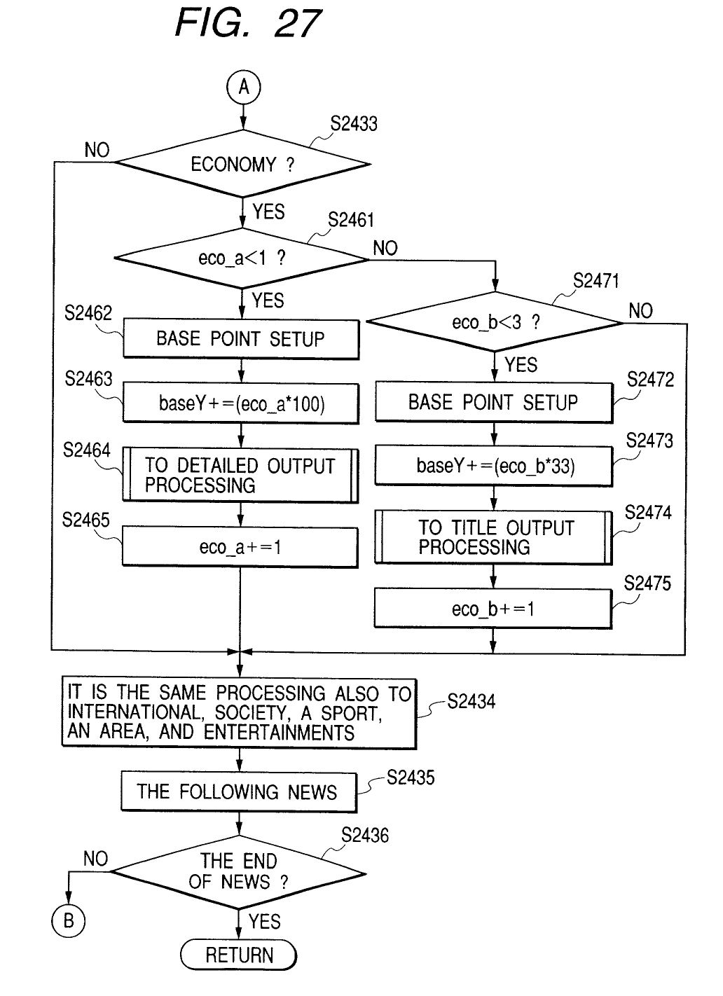

FIGS. 26 and 27 show a flowchart for describing the details of each category news executed in step S2405.

In each category news processing, at first the system initializes each category news item count variable (0 clear: pol_a=pol_b=0, etc.) in step S2431. The variable “pol_a” stores the frequency count of the detailed output processing for the “politics” category. The variable “pol_b” is a variable for storing the frequency count of the processing for outputting only the title of the “politics” category. In the same way, variables of other categories than the “politics”, for example, the variable (eco_a, eco_b=0) of the “economy” category is also initialized.

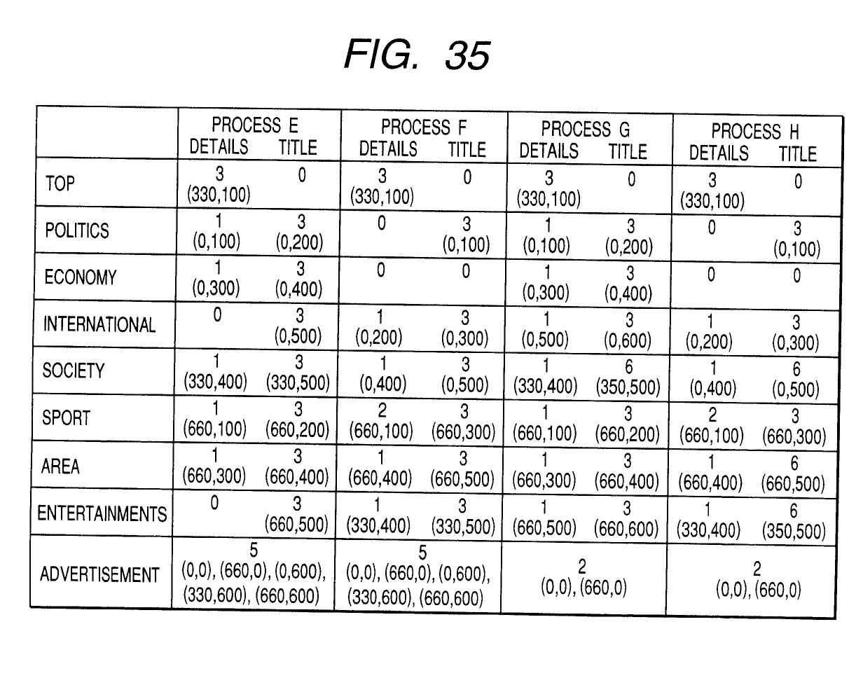

And, as shown in FIG. 35, the maximum number of items for printing (POL_A_MAX, ECO_A_MAX, etc.) is preset for each category with respect to a news item for which a detailed output processing is executed and a new item for which only the title printing is done according to each processing method. Those set information items are stored in the memory 107.

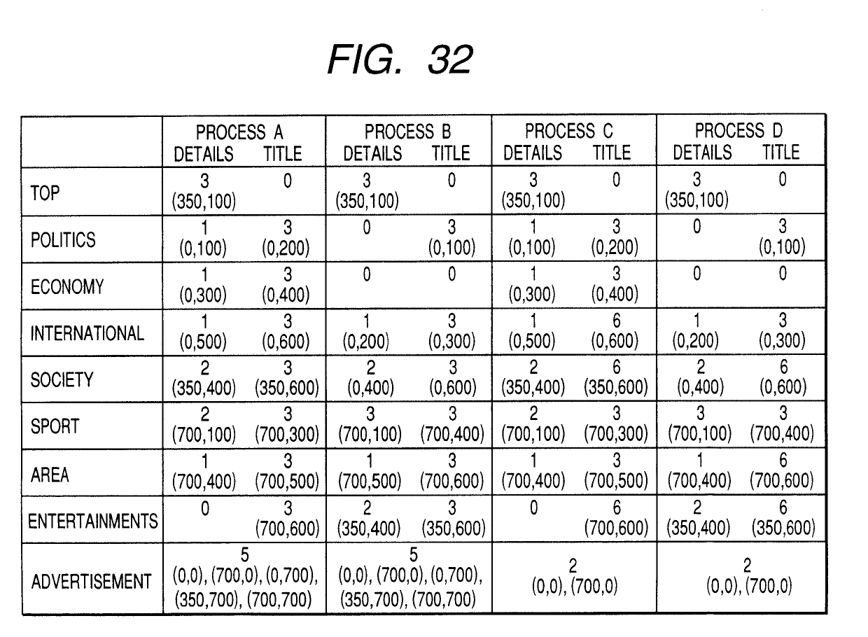

In the next step S2432, the system reads the category attribute of the <news item> tag of the current target news. When the category attribute is “politics”, the system decides whether pol_a<POL_A_MAX is satisfied (however, the “processing A” satisfies POL_A_MAX=1) in step S2441. When the result is NO, the system reads the base point (X=0, Y=100 for the politic news in the processing A) set as shown in FIG. 32 in step S2442 and adds an offset to the base point in step S2443. The system then goes to step S2444. In step S2444, the system outputs the details just like in the processing described above. And, in step S2445, the system adds a variable “pol_a” to the XML data for printing, thereby the result becomes (pol_a+=1).

After the processings in steps S2433 and 2434, the system searches the subsequent news item and stores the searched news item in the above-described buffer area in step S2435, then goes to step S2432. Converting all the news in the receiving XML data to XML data for printing in step S2436, the system returns to step S2406 shown in FIG. 22.

The system then decides whether or not the category of the current target news is “politics”. Finding a news item in the “politics” category again, the system goes to step S2451, since the detailed output processing is already finished once for the “politics” according to the set value (POL_A_MAX=1 in FIG. 22) in step S2441.

In step S2451, the system decides whether or not pol_b<POL_B_MAX is satisfied (POL_B_MAX=3 is assumed for the “processing A”). The system then reads the base point for outputting only the title of the news from the memory 107 in step S2452 and adds an offset to the base point in step S2453. The system then goes to step S2454. After this, the system outputs the title in step S2454.

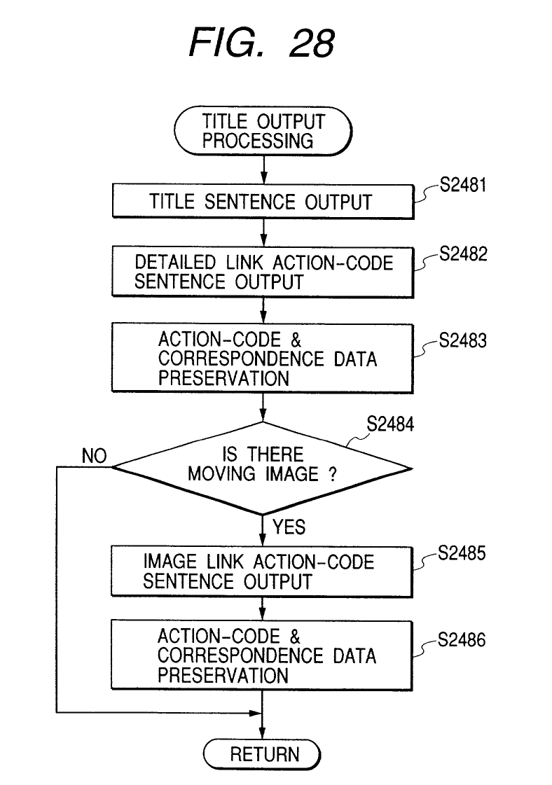

FIG. 28 shows a flowchart for describing the details of the title output processing executed in step S2454.

In this title output processing, at first the system outputs (adds) a program sentence for printing a news title to the XML data for printing in step S2481. At this time, the style information for specifying a printing position is calculated by the following expression E.

Equation E:

Title(X,Y,W,H)=(baseX,baseY,160,20)

The system then generates an action code for linking the news title with both text and image information, that is, the news detail information and outputs (adds) a program sentence to the XML data for printing. The sentence describes text information that denotes an action code corresponding to the “details” action. This action code, the text information (<news text> </news text>) tag content) and the image information (<news img> </news img> tag content) are corresponded to each another and they are all stored in the memory 107 (step S2483). The file data (image data) stored in a file denoted by the image information is transferred to and stored at the hard disk 123.

In the case where the system finds a <news movie>tag that denotes a movie in the current target news item in step S2484, the system generates an action code for linking the news item with a movie image in step S2485 and outputs (adds) a program sentence that describes both action code printing state and printing position information to the XML data for printing. This action code and the movie information (<news movie> tag content) are corresponded to each other and they are stored in the memory 107 (step S2486). The file data (movie image data) stored in a file denoted by the movie information is then stored at the hard disk 123. The system then returns to step S2445 in FIG. 26 so as to add a variable “pol_b” to the data and stores the result at the hard disk 123 as (pol_b+1).

Ending the processings in steps S2433 and S2434, the system goes to step S2435 so as to execute the processing as described above. The system also executes the same processing for the “economy” category (steps S2461 to S2465, and steps S2471 to S2475). Although not shown in FIGS. 26 and 27, the system also executes the same processings for each of “international”, “society”, “sport”, “area”, and “entertainment” categories.

In this case, because the title output processing frequency for the “politics” category is set to three times (POL_B_MAX=3), the detailed output processing is done only for one item and the title output processing is done for three items with respect to the news in the “politics” category. For the news items in other categories, the output processing is done in the same way according to the maximum number of printing items set for each category shown in FIG. 32.

Such way, the system creates XML data for printing with respect to each news item in each category. In the case where the next news item is not searched in step S2436, the system returns to FIG. 22 so as to execute an advertisement processing in step S2406.

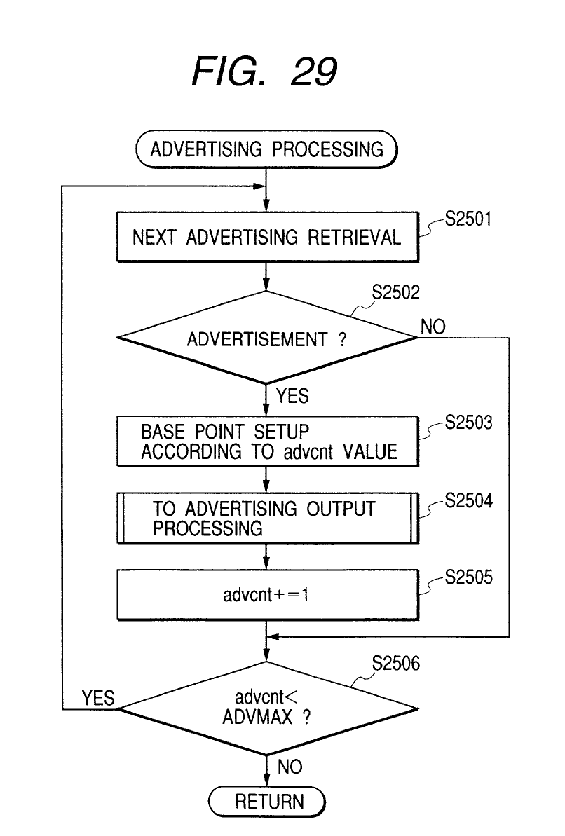

FIG. 29 shows a flowchart for describing an advertisement processing executed in step S2406 in FIG. 22.

At first, the system searches an <adv item> tag from the receiving XML data stored in the memory 107 in step S2501. When the tag is found, the system sets a base point that specifies the printing position of each advertisement in accordance with the value set in the variable “advcnt” that counts the advertisement output processing frequency with use of the following expression G.

Equation G:

if advcnt==0 then baseX=0,baseY=0

if advcnt==1 then baseX=700,baseY=0

if advcnt==2 then baseX=0,baseY=700

if advcnt==3 then baseX=350,baseY=700

if advcnt==4 then baseX=700 m,baseY=700

After this, the system executes an advertisement output processing in step S2504.

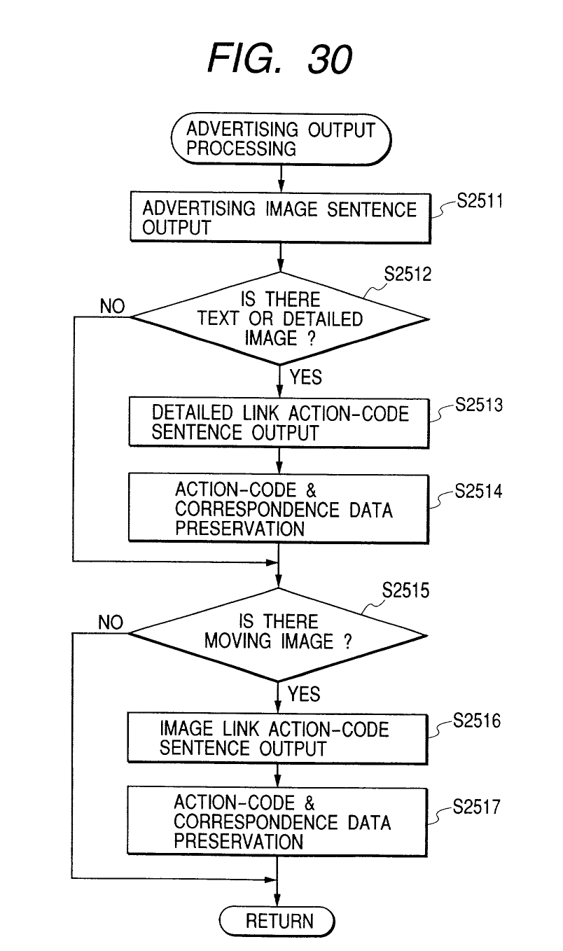

FIG. 30 shows a flowchart for describing the advertisement processing executed in the step S2504.

In this advertisement output processing, the system outputs a program sentence for printing each advertisement image. In this processing, the style information that specifies a printing position uses the base point value set in the step S2503 as is. The system then decides whether or not the target advertisement item includes text data or a detailed image (image data)(step S2512). When the decision result is YES, that is, when any of the <adv text> or <dev detailimg> tag is found, the system generates an action code and outputs (adds) a program sentence to the XML data for printing (step S2513). The program sentence includes text information that denotes the generated action code corresponded to the “details” action.

This action code, the text information (<adv text> </adv text> tag content), and the image information (<news detailimg> </news detailimg> tag content) are corresponded to each other in step S2514 and stored together in the memory 107. The file data (image data) stored in a file denoted by the image information is transferred to and stored at the hard disk 123.

The system then decides whether or not the current target advertisement item includes movie information (step S2515). When the decision result is YES, that is, when a <adv movie> tag is found, the system generates an action code in step S2516 and outputs (adds) a program sentence to the XML data string for printing. The program sentence includes text information that denotes the generated action code corresponded to the “movie” action. This action code and the movie information (<adv movie> </adv movie> tag content) are corresponded to each other and stored together in the memory 107 (step S2517). The file data (movie image data) stored in a file denoted by the movie information is then transferred to and stored at the hard disk 123.

The following is an example of the information stored in the memory 107.

action_code=000 action=“image” data=“news.mpeg” start=“330” length“30”;

action_code=005 action =“details” img=“xxx.jpg” text=“xxxxxxxxxxxxxxxxxxxxxx”;

In the information stored in the memory 107, both action code and action information (text information, image information, and movie information) are corresponded to each other such way.

<Storing and Printing XML Data for Printing>

In the processings (processing A) executed in steps shown in FIGS. 22 and 24 through 30 as described above, the system converts receiving XML data to XML data for printing, then stores the XML data as shown in FIG. 23 at the hard disk 123 in step S2309 shown in FIG. 20.

The system then starts printing according to this XML data for printing in step S2310 shown in FIG. 20. In this printing processing, the XML data for printing is converted to bit map data to be laid out and printed in both font and color decided according to the style information set in the above processing, then sent to the printer 132. In the case where the print data includes image data, the image data is read from the hard disk 123 and converted to bit map data for printing. The bit map data for printing is then output to the printer 132 via the IEEE 1394I/F 122.

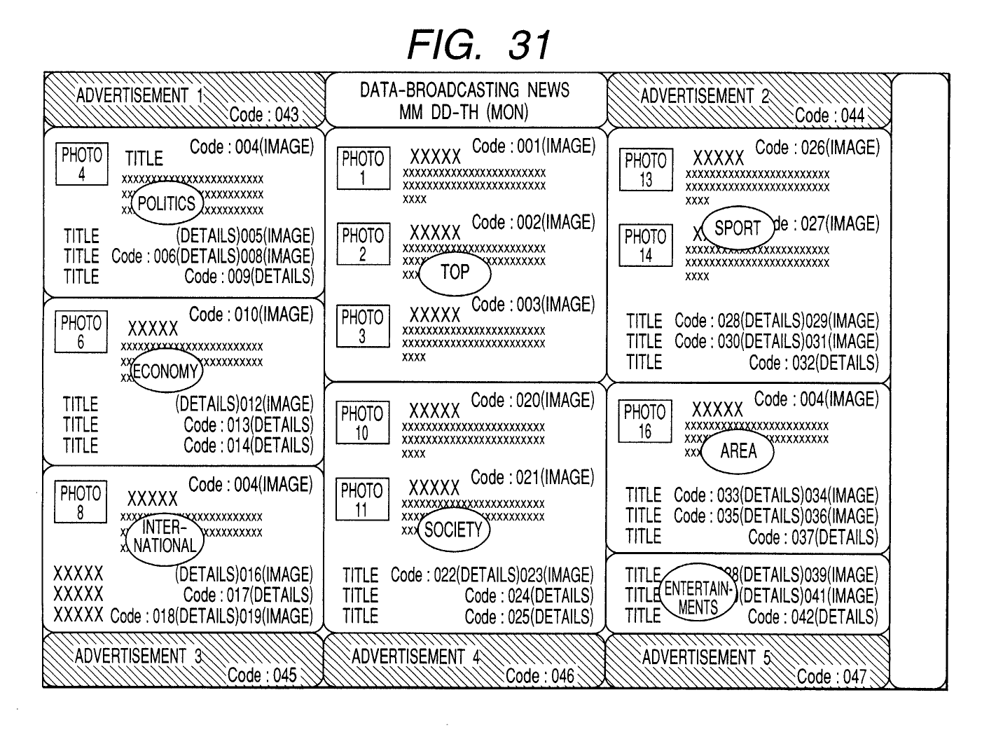

FIG. 31 shows a printing result of the “processing A”. The title and the date and time are printed in the top center of the form. Under them are printed three top news items together with their photos and texts. Surrounding the top news are laid out each category news. For example, a “politics” news item is printed together with a photo and a text and only the titles are printed for other three items. And, five advertisement items are laid out around news items in other categories. An action code is printed out in red at the side of each news and advertisement.

The “politics” and “economy” portions enclosed in circles are not actually printed out; they are described just for explanation. <Creating XML Data for Printing: Processing Methods Other than “Processing A”>

While the description has been made for the “processing A” so far, this embodiment is not limited only to the processing A; as described above, there are also “processing B”, “processing C”, “processing D”, etc. All of those processing types are not necessarily shown in the flowcharts; constant parameters are just changed in the flowcharts shown in FIGS. 22, and 24 through 28.

FIG. 32 shows differences among “processing A”, “processing B”, “processing C”, and “processing D”. Numbers in both detail and title fields in FIG. 32 show the number of news items for which the detail information including text and photo in each category and the number of news items for which only the titles are printed out. The data in parentheses shows coordinates (X,Y) of the base point for an XML sentence output processing of each news item.

Those data items are affected in the base point coordinate value set in each of the variables of “TOPMAX”, “POL_A_MAX”, “POL_B_MAX”, “ECO_A_MAX”, “ECO_B_MAX”, “baseX”, and “basey” in the flowcharts shown in FIGS. 22 and 24 through 30. For example, for the “processing B”, the value of “POL_A_MAX” becomes 0 and the base point becomes baseX=0 and baseY=100 for the “title only” of a politics news item.

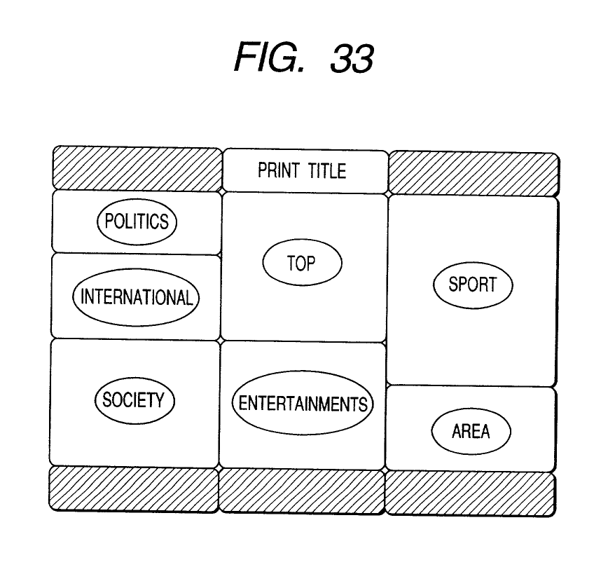

FIG. 33 shows a simplified layout made by the processing B”.

As to be understood apparently from FIG. 33, the spaces of both politics and economy news items in the “processing B” are reduced more than those of the “processing A” while the space of both sport and entertainment news items are expanded to absorb the reduction.

The number of advertisement items in the “processings C and D” is less than that in the “processings A and B” while more news items are printed out. As described above, this embodiment uses the table as shown in FIG. 7 and selects a processing for each user and for each day of the week. (The output content and the layout differ among days of the week.) Concretely, it is possible to set for USER0 so that the data of the “processing A” is printed out on week days and the data of the “processing B” is printed out on Sunday.

<Customization by User>

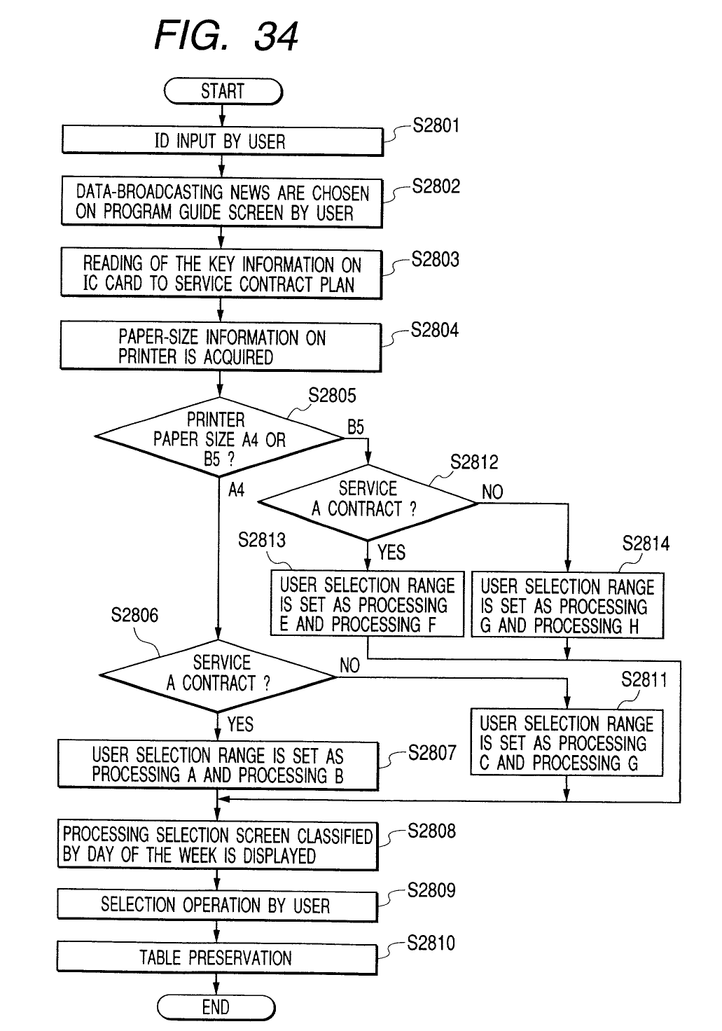

FIG. 34 shows a flowchart for printing a data-broadcasting program to be reserved by the user.

The user is requested to enter the user ID beforehand (step S2801). When the user selects a data-broadcasting news program on the electronic program guide (EPG) screen in step S2802, the system displays the receiving time setting screen (not shown). The user can set any receiving time within the broadcasting time of the selected data-broadcasting news program. On the receiving time setting screen, the user can also set a day of the week for receiving the selected data-broadcasting news program together. In this embodiment, a news program is set so as to be received at a predetermined time every day. The system stores both receiving time and day of the week that are set above, as well as such information as the selected program channel number, etc. required to receive the program in the memory 107.

In step S2803, the system reads the user's service contract information from the IC card control unit 117. The service contract mentioned here is divided into two types; “service A” and “service B”.

And, the system reads the print form size information for the printer 132 via the IEEE1394 interface in step S2804. When the form size is found to be A4 in step S2805, the system checks the service contract in step S2806. When the service type is A, the system sets the user selection range to “processing A” and “processing B” in step S2807. On the other hand, when the service type is B, the system sets the user selection range to “processing C” and “processing D” in step S2811.

After this, the system displays the processing selection screen classified by day of the week as shown in FIG. 22 on the screen of the image display 112 in step S2808. When the user service contract is A, only the “processing A” and the “processing B” are displayed as choices on this screen. When the user service contact is B, only the “processing C” and “processing D” are displayed as choices on this screen. The processing selection screen classified by day of the week is displayed according to the receiving day of the week set as described above.

When the user sets “a processing” on each day of the week on the screen in step S2809, the set information is stored in the memory 107 as “a weekly table” in step S2810. On the other hand, the system finds the form size to be B5 in step S2805 and the user service contract to be A in step S2812, the “processing E” and “processing F” are set as the user's selection range, thereby only the “processing E” and “processing F” are displayed as choices on the screen. When the system finds the user service contract to be B, “processing G” and “processing H” are set as the selection range, thereby only the “processing G” and the “processing H” are displayed as choices on the screen.

FIG. 35 shows parameters for the number of printing items and display positions in each category in those “processings E, F, G, and H”.

<Processings for Watching>

Next, a description will be made for the processings for watching a data-broadcasting program while the user sees an actually printed form.

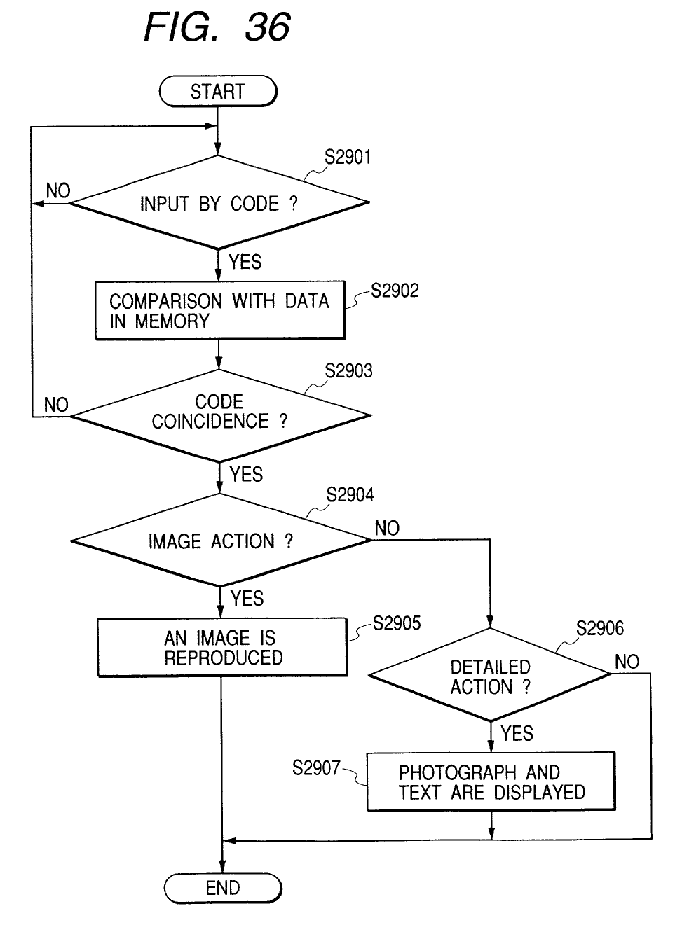

FIG. 36 shows a flowchart for describing the processings for watching the program.

At first, when the user enters an action code with reference to the printed form shown in FIG. 33 in step S2901, the system compares this entered action code with the corresponding action code stored in the memory 107 in the above processing in step S2902. When the result is YES (coincidence)(step S2903), the system reads the corresponding action from the memory 107.

In the case where the action information is “movie”, the system reads the specified movie data file from the hard disk 123 and reproduces the movie data. For example, when the user enters a “000” code, the system reproduces the movie data from the “news.mpeg” file stored at the hard disk 123 for 30 seconds, starting at the 330th second. On the other hand, when the action content is “details”, the system reads the specified image data from the hard disk 123 and the text information from the memory 107 so as to display both text information and image (photo) on the screen.

In the case where the user is requested to enter an action code, the user presses the action code button (red key) 206 on the remote control device shown in FIG. 2, then enter a three-digit number. In addition to the action code button (red key), the remote control device in this embodiment is provided with other keys. The same color (red) is therefore used for an action code printed on form and its corresponding action code button on the remote control device, thereby the user can avoid confusion in key operation. The user may use any color for such the correspondence between a printed action code and its corresponding remote control button.

According to this embodiment, the TV receiver that can receive data-broadcasting is enabled to print out information related to data-broadcasting contents so as to help the user watch data-broadcasting contents with simple operation and change the layout of the contents to be printed out, the output contents themselves, etc. appropriately to each of a plurality of users, each user can be provided with information of data-broadcasting contents customized to the user. Consequently, it is possible to facilitate the user to watch desired data-broadcasting contents accurately and easily.

Furthermore, because information related to data-broadcasting contents is printed on form in this embodiment, more information items can be introduced on the form. In addition, it is possible to change the print-out layout, the contents themselves, etc. according to the user's request, thereby information introduction efficiency can be improved much more by providing the user with only the information required by the user.

While it is enabled to change processings once on each day of the week in this embodiment, it is also enabled to change processings twice per day; in the morning and in the evening and/or on week days and on holidays.

While it is enabled to receive data-broadcasting program at a predetermined time and reserve printing at a predetermined time, such the printing may be started upon a request of the user without reserving printing. In this case, a data-broadcasting program specified by the user may be kept updated in a memory by receiving the updated program so as to store the latest data in the memory.

[Fourth Embodiment]

While information of only one data-broadcasting program is printed out in the third embodiment, the present invention is not limited only to that; it is possible to combine a plurality of data-broadcasting programs, as well as the status information of the TV receiver so as to display them all together. Hereunder, such an example will be described as the fourth embodiment of the present invention.

<Receiving Data-broadcasting>

For example, it is assumed that four data-broadcasting programs of “data-broadcasting news”, “data-broadcasting stocks watching”, “data-broadcasting weather report”, and “data-broadcasting leisure” are to be received at a predetermined time respectively in step S2301 shown in FIG. 20, then creating of XML data for printing is started at a user preset time in step S2304.

<Creating XML Data for Printing>

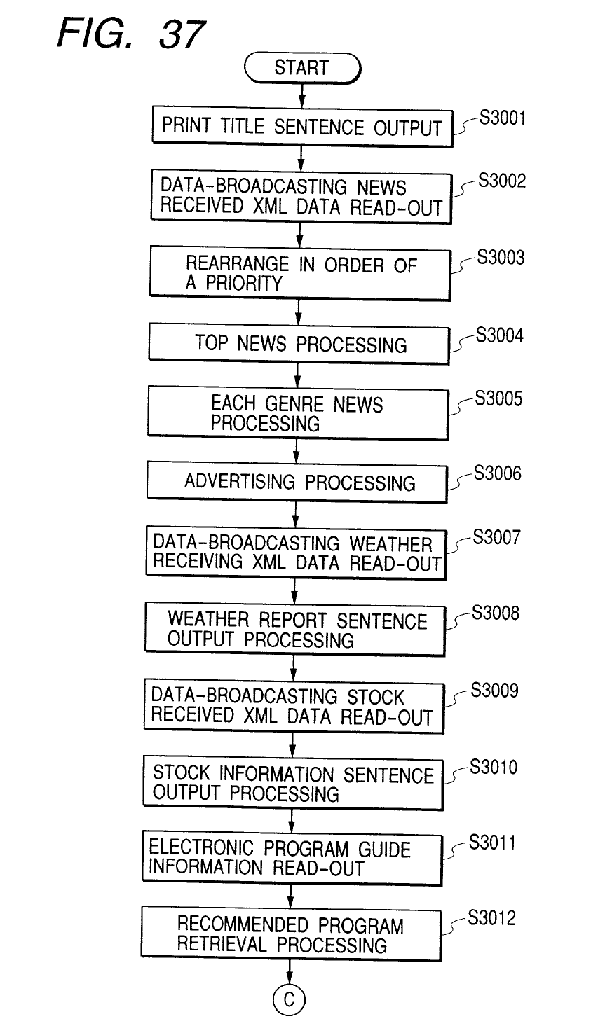

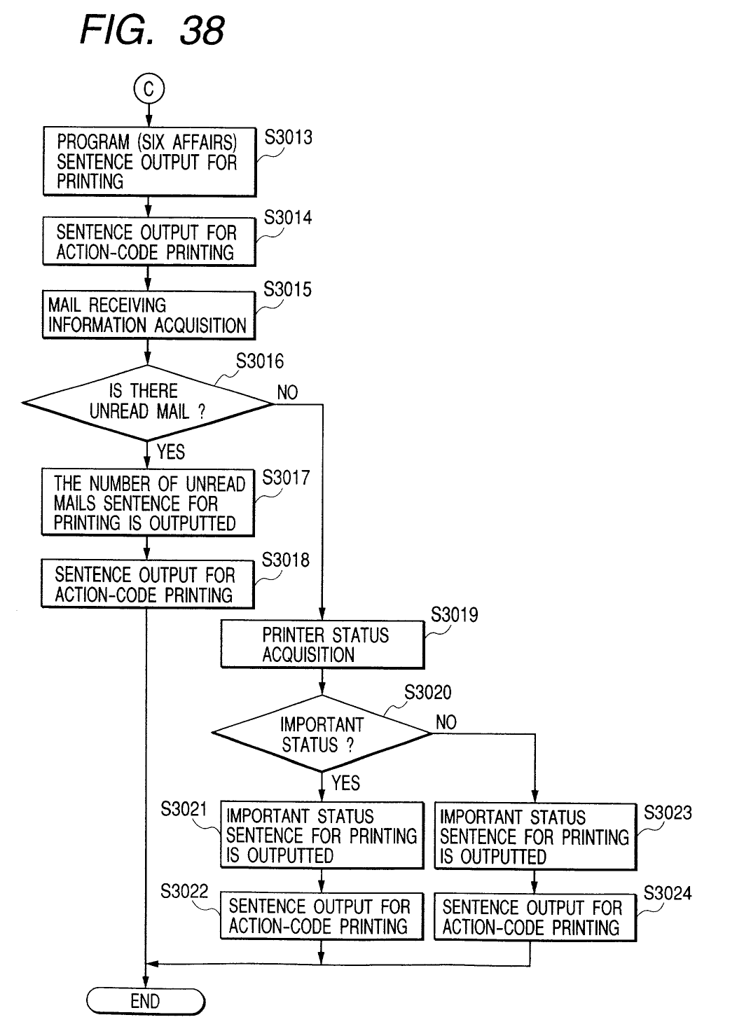

FIGS. 37 and 38 show a flowchart of the “processing X” for generating XML data for printing with use of a plurality of receiving XML data items and the status information of the TV receiver or a peripheral device.

In the “processing X”, the system outputs a program sentence for printing a title in step S3001. Then, the system reads the receiving XML data of “data-broadcasting news” in step S3002 and rearranges the data in order of their priority levels (step S3003), then executes the top news processing in step S3004, each category news processing in step S3005, and an advertisement processing in step S3006 just like in the third embodiment. The system then generates a program sentence for printing the top news, each category news in processings shown in FIG. 22 and 24 through 28 in the above-described third embodiment, and the advertisement, as well as an action code for reproducing movie data related to each news and displaying characters and images. The system then adds the program sentence and the action code to the XML data for printing.

Furthermore, the system reads the receiving XML data of “data-broadcasting weather report” in step S3007, then adds a program sentence for printing the weather report to the XML data for printing in step S3008. Then, the system reads the receiving XML data of “data-broadcasting stocks watching” in step S3009 and adds a program sentence for printing the stocks information to the XML data for printing in step S3010.

After this, the system reads the received EPG (electronic program guide) information in step S3011 and searches a program recommended according to the condition preset by the user from among the programs to be broadcast on that day. The system then generates a program sentence for printing six recommended programs and an action code for the processing for reserving recording of each program and adds the program sentence for printing the action code to the XML data for printing in steps S3013 and 3014.

In steps S3015 and S3016, the system inquires from the electronic mail application about whether or not there is any unread mail. In the case where there is an unread mail, the system generates a program sentence for printing the number of unread mails and an action code for starting up the mail application in steps S3017 and S3018. The system then adds the program sentence for printing the action code to the XML data for printing.

When there is no unread mail, the system reads the status of the printer 132 in step S3019. In the case where the system detects such an important state as shortage of the residual ink in step S3020, the system generates a program sentence for printing the printer state and an action code for reproducing the movie that shows an ink cartridge replacement procedure in steps S3021 and S3022, then adds the program sentence for printing the action code to the XML data for printing.

In the case where the system detects no important state in the printer 132, the system executes the same advertisement processing as that in step S3006 and adds a program sentence for printing the advertisement to the XML data for printing in steps S3023 and S3024.

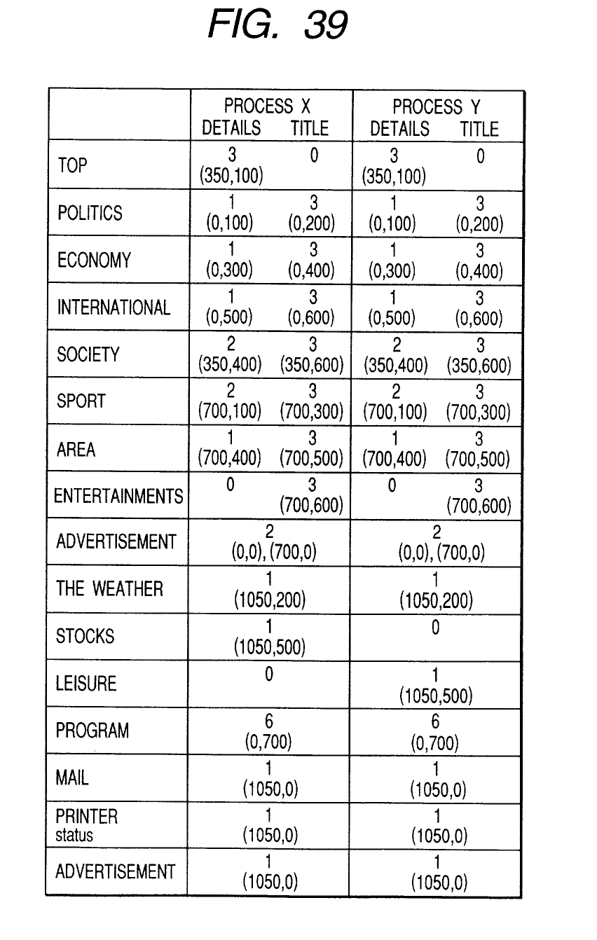

The “processing X” flow is as described above. FIG. 27 shows a table that denotes the number of information items and the printing layout output by this “processing X”. FIG. 27 also shows the processing Y”, which is the same as the “processing X” while information contents and layout are different. As to be understood from FIG. 39, in the “processing Y”, the system reads the receiving XML data of “data-broadcasting leisure” instead of “data-broadcasting stocks watching” in the “processing X” and adds a program sentence for printing information to the XML data for printing.

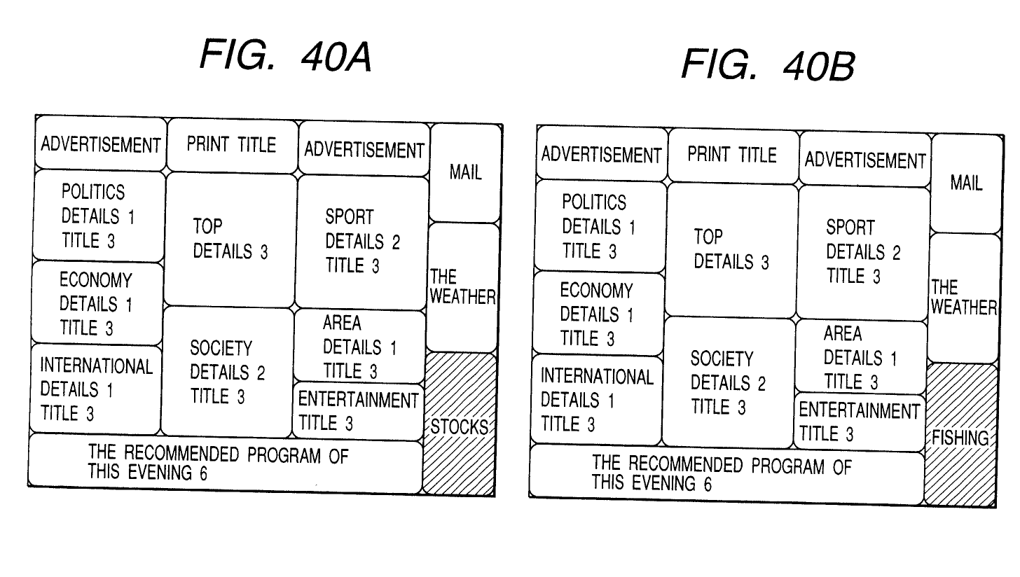

FIGS. 40A and 40B show printing results of the “processing X” and the “processing Y”. FIG. 40A shows a printing result of the “processing X” and FIG. 40B shows a printing result of the “processing Y”.

In this fourth embodiment, it is possible to print out not only a single data-broadcasting content, but also contents selected from a plurality of data-broadcasting contents, digital TV state information, state information of a physical device connected to the digital TV receiver, etc., thereby displaying information items required by the user collectively. The user can thus know his/her desired information accurately and easily.

The first to fourth embodiments described above can also be modified as follows.

(1) While both position information and font size of characters and images are specified according to XML data for printing in the above embodiments, the specified values do not have a position and size corresponding to those printed actually in dots by a printer at the one-to-one correspondence; the values are basically specified in units of about 100 dpi. Therefore, according to the performance of the subject printer, font sizes and printing positions are expanded in dots in actual printing.

(2) While a three-digit number is used for each action code in the above embodiments, the number of digits and the selection range of numbers are not limited only to that; any number of digits and any number range are allowable.

(3) While no display layout is included in any received “receiving XML data” in the above embodiments, such the receiving XML data may include display layout information.

(4) While a hard disk unit is used as a recording unit for recording received data-broadcasting contents in the above embodiments, any of other recording units may be used. In the same way, while a memory is used to record data that denotes a relationship between each code and XML data for a display in the above embodiments, any of other recording units may be used for that.

(5) While data-broadcasting news and shopping programs are assumed as data-broadcasting contents in the above embodiments, those embodiments may be modified so that a list of movies is printed out as a movies guide program and an advertisement movie film for those movies may be reproduced when the action code is entered and a test form is printed out as an educational program and a movie for showing how to solve the problems of the test may be displayed when the action code printed out on the test form is entered. In addition, a movie for showing how to cook a dish printed on a cooking magazine when the code printed on the magazine is entered and a list of movies that are currently showing is displayed when the code printed on a movie magazine is entered. Furthermore, an advertisement movie film is reproduced when the code printed out at the side of the movie on form is entered.

(6) In the above embodiments, in the case where a program as shown in each flowchart described above is stored, for example, at the hard disk 123 and executed, each control in each of those embodiments can be realized.

(7) While an action code is assigned to each of processings for displaying detailed information of each data-broadcasting program and its related movie image, each processing to which an action code is assigned may be a processing for executing a program transferred by broadcasting waves and/or a processing for displaying an operation guide used to eliminate troubles of the digital TV broadcasting receiver.

(8) In addition to the apparatuses in the above embodiments, the present invention may also apply to a system configured by a plurality of devices or a single device. A recording medium that stores software program codes for realizing the functions in the above embodiments may be employed for a system or apparatus and the computer (or CPU and/or MPU) of the system or apparatus may read and execute the program codes stored in the recording medium.

In this case, each program code itself read from the recording medium realizes a function in the above embodiments. The recording medium that stores those program codes thus comes to configure the present invention. The recording medium that supplies those program codes may be, for example, any of the floppy disk, the hard disk 123, an optical disk, an optical magnetic disk, a CD-ROM, a CD-R, a magnetic tape, a non-volatile memory card, and a ROM. While a computer reads and executes program codes so as to realize the functions of the above embodiments, an OS that runs in the computer may execute part or whole of the actual processing according to each of the program codes so as to realize each of the functions of the above embodiments through the processing.

Furthermore, a program code read from the recording medium is written in an expansion board installed in the computer or in a memory provided in an expansion unit connected to the computer, then the CPU or the like provided in the expansion board or unit may process the program code according to the next program code so as to execute part or whole of the actual processing and realize each of the functions of the above embodiments through the processing.

As described above, according to the present invention, therefore, it is possible to provide each user with data-broadcasting services for supplying various information items by linking print outputs with movie images, still images, and voices, thereby facilitating the user to find interesting information by zapping mass of information printed on form at any place and at any style and entering a few-digit code so as to check more detailed information composed of movie images, voices, characters, still images, etc. on such a monitor screen as a TV screen, etc., since the present invention enables those data-broadcasting services to use an advantage of “form”, which are “light”, “easy to bring about”, and “easy to read”, etc.

Furthermore, because each code is assigned in such a main unit as a receiver, etc., the user can assign a code to his/her desired data and execute his/her desired operation specified by the less-digit code. Concretely, the user can select his/her desired information from among mass of supplied information with a simple operation.

Furthermore, because each of a plurality of users can obtain printed information about the optimized data, the user can have data customized just to him/her.

Furthermore, the user can have desired information efficiently when information related to desired data is printed out on form, since useless information for the user is not printed out.

Furthermore, the user can obtain a plurality of necessary information items collectively, so that the user can have the information accurately and easily.

What is claimed is:

1. An information processing apparatus, comprising:
input means for entering a data string composed of a plurality of information, said data string being output onto display means;
extracting means for extracting information automatically from said data string entered by said input means according to a predetermined condition;
generating means for generating print data for printing the information extracted by said extracting means; and
output means for outputting the print data generated by said generating means to printing means.

2. An apparatus according to claim 1, wherein identification information for identifying each of a plurality of said information is added to each of a plurality of said information; and
said extracting means extracts information according to said predetermined condition and said identification information.

3. An apparatus according to claim 2, wherein said identification information denotes an item in accordance with a data format and the content of each of a plurality of said information.

4. An apparatus according to claim 1, wherein said data string composed of data described with a markup language.

5. An apparatus according to claim 1, wherein a plurality of said information include any one of text information for denoting characters, patterns, etc., still image data, movie image data, and voice data.

6. An apparatus according to claim 1, wherein said data string is sent by digital data-broadcasting.

7. An apparatus according to claim 1, wherein said generating means generates said print data so as to make information extracted by said extracting means correspond to printing position information and/or printing size information.

8. An apparatus according to claim 1, further comprising:
condition setting means for setting said predetermined condition,
wherein said extracting means extracts said information according to said condition set by said condition setting means.

9. An apparatus according to claim 8, wherein said condition setting means sets said condition according to the date and time of said data string entry by said input means or according to inputs by a plurality of operators.

10. An apparatus according to claim 1, wherein said predetermined condition differs among service types for sending a plurality of information items entered by said input means.

11. An apparatus according to claim 10, wherein said predetermined condition specifies a rate of advertisement information to the information extracted by said extracting means, differently among said service types.

12. An apparatus according to claim 1, wherein said predetermined condition specifies the number of items of information extracted by said extracting means for each category of a plurality of said information items.

13. An apparatus according to claim 1, further comprising:
processing means for executing a plurality of processings for a plurality of said information held in said data string entered by said input means;
assigning means for assigning a code automatically to a processing of information extracted by said extracting means; and
controlling means for controlling said processing means so as to process said information according to a code assigned by said assigning means.

14. An apparatus according to claim 13, wherein a plurality of said information include information distributed by data-broadcasting; and
said assigning means assigns said code to at least any one of a display of images including still images and movie images, a display of text information denoting characters, patterns, etc., a voice output, and a program execution related respectively to information extracted by said extracting means.

15. An apparatus according to claim 13, wherein said code is output to said printing means so as to correspond to information related to said assigned processing.

16. An apparatus according to claim 15, further comprising:
code input means for entering a given code manually, wherein said controlling means controls said processing means according to a code entered by said code input means and said assigned code.

17. An apparatus according to claim 16, wherein said code input means has a color button used to enter a code and said printing means prints out said code in the same color as that of said color button when said code is to be printed out.

18. An apparatus according to claim 13, further comprising:
code input means for entering a given code manually, and
wherein said controlling means controls said processing means according to a code entered by said code input means and said assigned code.

19. An apparatus according to claim 18, wherein
a plurality of said information include second code information that makes a second code correspond to a processing executed by said processing means, and
said controlling means controls said processing means according to said second code entered by said code input means and said second code information.

20. An apparatus according to claim 19, wherein said code input means has a color button used to enter a code and said second code is printed out on a publication in the same color as that of said color button and/or displayed as information via a network.

21. An apparatus according to claim 1, further comprising:
data sending means for sending a printing result to an external information processing apparatus when said printing result is output from said output means to said printing means.

22. An information processing apparatus, comprising:
processing means for executing a plurality of processings for a plurality of entered information;
information selecting means for selecting an information from among a plurality of said information according to a predetermined condition;
assigning means for assigning a code automatically to a processing for said information selected by said information selecting means; and
controlling means for controlling said processing means so as to process said information according to a code assigned by said assigning means.

23. An apparatus according to claim 22, wherein said selecting condition is set to select at least any one of information distributed by data-broadcasting, information denoting the state of said signal processor, information denoting the state of a peripheral device connected to said signal processing apparatus, and TV program information.

24. An apparatus according to claim 22, wherein said selecting condition is set to specify the number of items of information selected by said information selecting means for each category of a plurality of said information.

25. An apparatus according to claim 22, further comprising:
output means for outputting print data to a printer, said printer data being used to print information selected by said information selecting means and a code assigned by said assigning means so that they correspond to each other;
code input means for entering a given code manually; and
controlling means for controlling said processing means so as to execute a processing according to a code assigned by said assigning means and a code entered by said code input means.

26. An apparatus according to claim 25, further comprising:
generating means for generating said print data, and
wherein said generating means generates said print data according to the type of said information, the number of items of said information, and printing position information of said information set respectively according to said selected condition.

27. An apparatus according to claim 22, further comprising:
output means for outputting image data or text data related to any of a plurality of said information to display means,
wherein a plurality of said information include image data including still images and movie images or text data denoting characters, patterns, etc.

28. An apparatus according to claim 22, wherein
a plurality of said information include information distributed by data-broadcasting, and
said assigning means assigns said code to at least any one of a still image display, a text display, a voice output, and a program execution related respectively to said selected information.

29. An apparatus according to claim 22, wherein
a plurality of said information include information denoting the state of said signal processor, and
said assigning means assigns said code to a predetermined processing according to the state of said processor.

30. An apparatus according to claim 22, wherein
a plurality of said information include information denoting the state of a software program installed in said signal processor, and
said assigning means assigns a code to a predetermined processing according to the state of said software program.

31. An apparatus according to claim 22, wherein
a plurality of said information include information denoting the state of a peripheral device connected to said signal processor, and
said assigning means assigns a code to at least any one of a control instruction issued to said peripheral device, a display of image information or text information related to the state of said peripheral device, and a voice output related to the state of said peripheral device.

32. An apparatus according to claim 22, wherein
a plurality of said information include information of a TV program, and
said assigning means assigns a code to a recording reservation setting processing related to said TV program.

33. An information processing method, comprising:
an input step of entering a data string composed of a plurality of information, said data string being output onto display means;
an extracting step of extracting information automatically from said entered data string according to a predetermined condition;
a generating step of generating print data for printing said extracted information; and
an output step of outputting said generated print data to printing means.

34. A method according to claim 33, further comprising:
a condition setting step of setting said predetermined condition, and
wherein said extracting step extracts said information according to said condition set by said condition setting step.

35. A method according to claim 34, wherein said condition setting step sets said condition according to the date and time on which said data string is entered by said input step or according to a plurality of operators.

36. A method according to claim 33, wherein said predetermined condition differs among service types for sending a plurality of information entered by said input step.

37. A method according to claim 36, wherein said predetermined condition specifies a rate of advertisement information to information extracted by said extracting step, said rate being varied among said service types.

38. A method according to claim 33, wherein said predetermined condition specifies the number of items of information extracted by said extracting step for each category of a plurality of said information.

39. A method according to claim 33, further comprising:
a processing step of executing a plurality of processings for a plurality of said information held in a data string entered by said input step;
an assigning step of assigning a code automatically to a processing of said extracted information; and
a controlling step of controlling said processing step so as to process said information according to said assigned code.

40. A method according to claim 39, wherein
a plurality of said information include information distributed by data-broadcasting, and
said assigning step assigns said code to at least any one of a display of images including still images and moving images, a display of text information denoting characters, patterns, etc., a voice output, and a program execution with respect to information extracted by said extracting step.

41. A method according to claim 39, wherein said code is output to said printing means so as to correspond to information related to said assigned processing.

42. A method according to claim 41, further comprising:
a code input step of entering a given code manually,
wherein said controlling step controls said processing step according to said entered code and said assigned code.

43. A method according to claim 42, wherein said output step prints out said code in a color specified by said code input step when said code is output.

44. A method according to claim 39, further comprising:
a code input step of entering a given code manually,
wherein said controlling step controls said processing step according to said entered code and said assigned code.

45. A method according to claim 44, wherein
a plurality of said information include information of a second code that makes said second code correspond to a processing executed by said processing step, and
said controlling step controls said processing step according to said second code entered by said code input step and said second code information.

46. A method according to claim 45, wherein said second code is printed out on a publication and/or displayed as information via network.

47. A method according to claim 33, further comprising:
a data sending step of sending a printing result to an external information processing apparatus when said printing result is output to said printing means by said output step.

48. A printer, comprising:
input means for entering print data generated by an information processing apparatus that generates said print data for printing information extracted automatically from a data string composed of a plurality of information according to a predetermined condition, said data string being output onto a display device; and
printing means for printing out said extracted information according to print data entered by said input means.

49. A data-broadcasting receiving apparatus, comprising:
receiving means for receiving data-broadcasting data composed of a plurality of information, said data-broadcasting data being output onto display means;
extracting means for extracting information automatically from data-broadcasting data received by said receiving means according to a predetermined condition;
generating means for generating print data for printing out information extracted by said extracting means; and
output means for outputting print data generated by said generating means to printing means.

50. An apparatus according to claim 49, wherein said predetermined condition specifies a category of said plurality of information.

51. An apparatus according to claim 49, further comprising:
reservation setting means for reserving an operation of said receiving means so as to receive data-broadcasting data related to a program installed in said data-broadcasting data at a predetermined time.

52. An apparatus according to claim 51, wherein said predetermined condition depends on said predetermined time set by said reservation setting means.

53. An apparatus according to claim 49, further comprising:
condition setting means for setting said predetermined condition, and
wherein said predetermined condition depends on user information set by said condition setting means.

54. An apparatus according to claim 49, further comprising:
processing means for executing a plurality of processings for a plurality of information held in the data-broadcasting data received by said receiving means;
assigning means for assigning a code automatically to a processing of information extracted by said extracting means; and
controlling means for controlling said processing means so as to process said information according to a code assigned by said assigning means.

55. An apparatus according to claim 54, wherein said assigning means assigns said code to at least any one of a display of images including still images, moving images, etc., a display of text information denoting characters, patterns, etc., a voice output, and a program execution with respect respectively to information extracted by said extracting means.

56. An apparatus according to claim 54, wherein said code is output to said printing means so as to correspond to information related to said assigned processing.

57. An apparatus according to claim 54, further comprising:
code input means for entering a given code manually, and
wherein said controlling means controls said processing means according to a code entered by said code input means and said assigned code.

58. An apparatus according to claim 57, wherein
said code input means has a color button used to enter a code, and
said printing means prints out said code in the same color as that of said color button when said code is to be printed out.
